(19) United States
(12) Patent Application Publication
(10) Pub. No.: US 2015/0154634 A1
(43) Pub. Date: Jun. 4, 2015

(54) METHOD AND SYSTEM FOR IMPLEMENTING TRANSACTIONS AND PROMOTIONAL OFFERS

(71) Applicant: KEEWEE TECHNOLOGY LIMITED, Hong Kong (CN)

(72) Inventors: Jason Felix Tsz-Kiu Chiu, Hong Kong (CN); Tak Ko Chan, Hong Kong (HK)

(21) Appl. No.: 14/558,585

(22) Filed: Dec. 2, 2014

(30) Foreign Application Priority Data
Dec. 2, 2013 (CN) 201310638090.2

(51) Int. Cl. G06Q 30/02; G06Q 20/32

(52) U.S. Cl. CPC G06Q 30/0253; G06Q 20/3278

(57) ABSTRACT

A method and a system for implementing transaction and/or promotional offers are provided. In an embodiment, the method includes testing multiple communication methods and choosing the optimal communication mode to process transactions and/or issuing promotional offers. The communication methods may include short-range communications. In an embodiment, the system detects the presence of mobile terminals in preset region, and may send commercial information, transaction information, and/or invitations. In an embodiment, the system supports mobile payment as well as other payment types.

### CROSS-REFERENCE TO RELATED APPLICATIONS

This application claims priority benefit of Chinese Patent Application Number CN201310638090.2 (Docket # BL-1-13), entitled “METHOD AND SYSTEM FOR IMPLEMENTING TRANSACTIONS AND PROMOTIONAL OFFERS,” filed on Dec. 2, 2013, by Jason Felix Chiu Tsz Kiu and Tak-Ko Chan, which is incorporated herein by reference.

### FIELD

The present specification relates to transactions and promotional offers.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

When a customer enters a store, the store assistant does not know the customer's identity and/or purpose (e.g., whether the customer has an order to pick up or wants to buy specific items), until the customer tells the store assistance or asks the store assistant to process a transaction. This specification recognizes the need to detect and/or identify the customers in the store and/or in a neighborhood of the store so as to provide better service to the customers and enhance the customers' experience, and to increase the rate of turnover of the store's inventory.

With the development of communication technologies, particularly the short-range communication, store systems and/or retail systems need to be updated to accept various payment types (e.g., contactless credit cards). Near field communication technology and/or other communication technologies may also be used to implement payment, reward systems, and/or other services. However, different systems using different communication technologies may lead to the loss of versatility and flexibility to process payments and issue promotional offers in different stores.

Currently when a customer makes a payment using a credit card or in other ways, in order to issue promotional offers, the customer needs to be registered in a loyalty or reward program and the amount of consumption needs to be recorded in the loyalty or reward program. If the customer wants to make a payment using a contactless credit card having the Visa payWave feature, for example, a card reader that can accept Visa payWave payments needs to be installed. Meanwhile, if the customer has a membership card linked to the loyalty or reward program, a card reader needs to be installed to identify the barcode or the magnetic stripe of the membership card in order to record the customer's consumption amount and issue promotional offers to the loyalty or reward program. Therefore, the payment and the issuance of promotional offers may be in separate steps.

In one embodiment, payment may be combined with the loyalty or reward program. For example, Macy's issues store credit card that is linked to a Macy's account to issue rewards on purchases made in Macy's store or made online using the Macy's credit card. Another example is the Bank of Communications & China Eastern Airlines credit card that is jointly issued by the Bank of Communications and China Eastern Airlines for customers to accumulate mileages as the members of Eastern Miles and/or earn bonus points at China Eastern Airlines and the partner stores using the credit card that was issued by the Bank of Communications or China Eastern Airlines. Although payments and rewards can be implemented in one step using the credit card that is linked to the store and/or reward programs, the customer can only choose specific credit cards in specific stores that are associated with or in partnership with the stores and/or reward programs. It is not flexible or convenient for the customer to use credit cards (or other payment types) that are not linked to the reward program to make a purchase and receive the promotional offers.

Currently only large stores may cooperate with banks to issue store credit cards that are linked to store accounts and/or reward programs. Smaller stores may not issue store credit cards and/or may only provide membership cards. Further, stores may accept credit cards and/or other payment types that are not directly associated with store accounts and/or reward programs.

As can be seen from the above, the current techniques have inconveniences and deficiencies in practical applications, and it may be desirable to make an improvement.

### SUMMARY

In view of the above deficiencies, in an embodiment a method and a system are provided for implementing transactions and promotional offers. In at least one embodiment, the system detects presence of mobile terminals in preset regions, pushes commercial information to the mobile terminals, invites customer to interact in various ways, processes transactions, and/or implements promotional offers. In at least one embodiment, the system includes at least a transaction terminal that tests communication methods with a mobile terminal and selects the optimal communication mode to transmit information and/or implement transactions and/or promotional offers. In at least one embodiment, the transaction terminal executes a payment transaction using data of mobile payment on the mobile terminal and issues promotional offers to the mobile terminal synchronously. In another embodiment, the transaction terminal accepts payment types other than mobile payments, and issues promotional offers to the mobile terminal.

In at least one embodiment, the system includes a presence detection device that detects the presence of a mobile terminal when the customer associated with the mobile terminal is in a preset region (e.g., in the vicinity of a store). In at least one embodiment, the transaction terminal and/or the presence detection device may retrieve from a server customer information related to the mobile terminal that enters the preset region, and may transmit commercial information and/or invitations to the mobile terminal for attracting the customer into the store to make purchases. In at least one embodiment, the presence detection device may detect the presence of mobile terminals close to the transaction terminal and send transaction information and/or payment request to the mobile terminal. In at least one embodiment, after detecting the presence of the mobile terminal of a customer, the system retrieves customer information and/or pickup order information and may alert the store assistance to prepare the ordered items for the customer to pickup.

In at least one embodiment, the system may process payments using any of the existing payment methods, and may implement promotional offers that can be stored and/or used on any type of mobile terminals. In at least one embodiment, the system improves the versatility and flexibility of transactions and/or promotional offers that can be offered to the customer, thus enhances customer experience.

Any of the above embodiments may be used alone or together with one another in any combination. Inventions encompassed within this specification may also include embodiments that are only partially mentioned, alluded to, or are not mentioned or alluded to at all in this brief summary or in the abstract.

### BRIEF DESCRIPTION OF THE FIGURES

In the following drawings like reference numbers are used to refer to like elements. Although the following figures depict various examples of the invention, the invention is not limited to the examples depicted in the figures.

FIG. 1 is a block diagram of a structure of a system for implementing transactions and/or promotional offers according to at least one embodiment;

FIG. 2 shows a diagram of another embodiment of the system of FIG. 1;

FIG. 3 shows a diagram of an embodiment of the system defining a preset region of a store;

FIG. 4A shows a diagram of an embodiment of the system including the presence detection device installed outside the store;

FIG. 4B shows a diagram of an embodiment of the system including the presence detection device installed inside the store and close to the transaction terminal;

FIG. 5A shows a diagram of an embodiment of the system processing transactions via mobile payment on the mobile terminal and issuing promotional offers synchronously;

FIG. 5B shows a diagram of an embodiment of the system processing transactions using payment types other than mobile payments and issuing promotional offers on the mobile terminal;

FIGS. 6A-C are flowcharts of an embodiment of a method of implementing transactions and/or promotional offers;

FIGS. 7A, 7B1 and 7B2 are flowcharts of an embodiment of a method of determining whether the mobile terminal is in the preset region associated with the store;

FIGS. 8A and 8B are flowcharts of an embodiment of another method of determining whether the mobile terminal is in the preset region associated with the store;

FIGS. 9A and 9B are flowcharts of embodiments of methods of detecting the presence of the mobile terminal in the preset region and implementing transactions and/or promotional offers;

FIG. 10 shows a block diagram of an embodiment of a server in the system;

FIG. 11 shows a block diagram of an embodiment of a transaction terminal in the system;

FIG. 12 shows a block diagram of an embodiment of a mobile terminal in the system;

FIG. 13 shows a block diagram of an embodiment of a presence detection device in the system;

FIG. 14 shows a diagram of a mobile terminal detector that may be used in the presence detection device of the systems of FIG. 1 and FIG. 13; and

FIG. 15 shows a diagram of an example of the presence detection device of FIG. 14.

### DETAILED DESCRIPTION

Although various embodiments of the invention may have been motivated by various deficiencies with the prior art, which may be discussed or alluded to in one or more places in the specification, the embodiments of the invention do not necessarily address any of these deficiencies. In other words, different embodiments of the invention may address different deficiencies that may be discussed in the specification. Some embodiments may only partially address some deficiencies or just one deficiency that may be discussed in the specification, and some embodiments may not address any of these deficiencies.

It should be understood that specific embodiments described herein are only used to explain at least one embodiment but not used to limit the present invention.

To facilitate understanding of the embodiments of the specification, a few terms are defined as follows.

Mobile payment refers to any of payment services operated under financial regulation and performed from, or via, a mobile device. Mobile payment may include E-wallets (e.g., Google Wallets, Apple Pay), online payment accounts (e.g. PayPal account), electronic stored-value cards on the mobile device (e.g., a Hong Kong Octopus Card installed on smart phones that have near field communication (NFC) devices), mobile applications that are linked to personal accounts (e.g., online credit card accounts, bank accounts, and/or prepaid accounts), and/or any payment methods that involve Short Message Service (SMS) based transactional payments, direct mobile billing, mobile web payments (WAP), and/or Near Field Communication.

Contactless credit cards refer to credit cards that use radio-frequency identification for making secure payments. Chips and/or antennas may be embedded in contactless credit cards, which enable a user to wave over or move close to a reader to complete payments. Examples of contactless credit cards may include, but are not limited to, credit cards or other cards, such as MasterCard PayPass, American Express ExpressPay, Visa payWave.

Short-range communication refers to communications over limited distances (e.g., within a distance less than 200 meters, 100 meters, 10 meters, 10 centimeters, 1 centimeter, or 0.1 centimeter). Short-range communication may include, but is not limited to, Bluetooth, Wi-Fi, near field communication, audio signals, infrared light, ultraband, Zigbee, for example.

Effective communication range refers to a range, or an area, within which the signal strength is sufficient for most receivers to decode. The effective communication range of different types of communication signals may be different. The effective communication range of signals may also depend on the transmitters and/or receivers, for example. The effective communication range of signals may also be affected by the structures of the environment and/or interferences.

Promotional offers refer to any type of promotional information including, but is not limited to, coupons, promotional discounts, promotional offering stamps, credits and/or points for memberships and/or loyalty programs, purchase credits, promotional offer points, mileages, promotional offer incentives, cash vouchers, and/or gift tokens, for example. Throughout this specification, the terms “promotional offer,” “promotional offer information,” “rewards,” and “coupon” are used interchangeably, and may be substituted one for the other to obtain different embodiments.

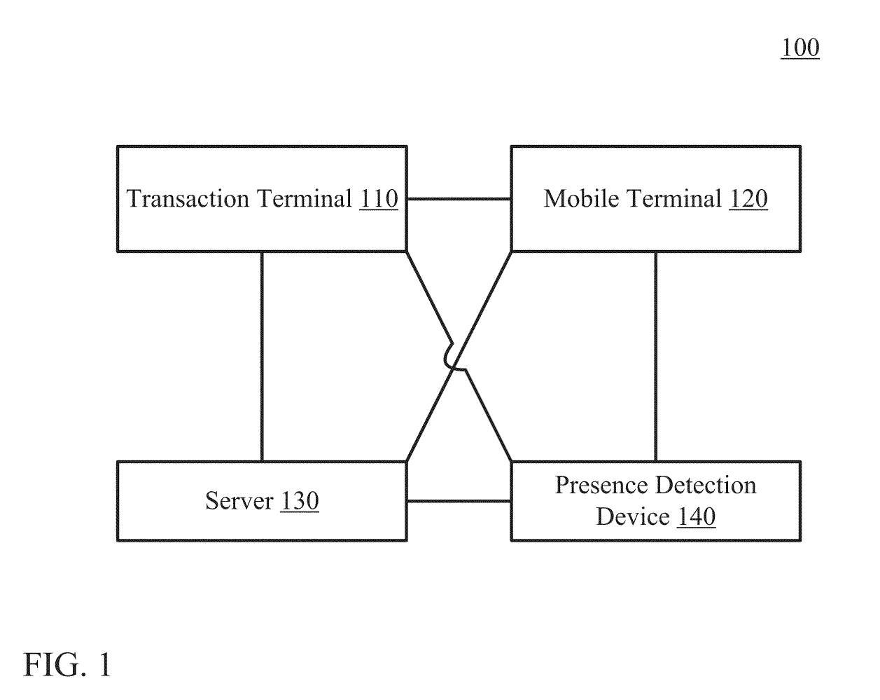

FIG. 1 illustrates a block diagram of a structure of a system 100 for implementing transactions and/or promotional offers according to at least one embodiment. System 100 includes at least a transaction terminal 110, a mobile terminal 120, a server 130, and a presence detection device 140. In other embodiments, system 100 may not have all of the elements or features listed and/or may have other elements or features instead of, or in addition to, those listed.

System 100 is a system for implementing transactions and/or promotional offers. In at least one embodiment, system 100 includes a transaction terminal that tests various short-range wireless communication methods with a mobile terminal. In at least one embodiment, the transaction terminal chooses the optimal communication mode to establish a connection with the mobile terminal for implementing transactions and/or promotional offers, pushing advertisements, and/or inviting customers to join games and/or activities for attracting customers into stores. In at least one embodiment, the transaction terminal communicates with a server, which may determine whether a mobile terminal enters a preset region of a store where the transaction terminal is installed. In at least one embodiment, the server may send information related to the customer associated with the mobile terminal to the transaction terminal, and the server and/or the transaction terminal may communicate with the mobile terminal to transmit commercial information, invitations, and/or promotional offers. In at least one embodiment, the transaction terminal may include, or may be connected to, a presence detection device, which may detect the presence of a mobile terminal within a preset region (e.g., within effective communication range from the presence detection device). In at least one embodiment, an application is installed on the mobile terminal that allows the customer to log into a user account for receiving commercial information, managing and/or processing payments and/or promotional offers. In at least one embodiment, the system 100 may accept mobile payment and/or other payment types that do not involve a mobile device, and may issue promotional offers to mobile terminals of the customer.

Transaction terminal 110 is a terminal used by a store and/or retailer for processing transactions, issuing promotional offers, transmitting commercial information, and/or transmitting invitations. In at least one embodiment, transaction terminal 110 communicates with mobile terminals of customers that are within a preset region associated with the store where the transaction terminal 110 is installed. In at least one embodiment, transaction terminal 110 may detect the presence of mobile terminals within the preset region associated with the store. In at least one embodiment, the transaction terminal 110 may also track and/or update data related to transactions, promotional offers, and/or inventory as the transactions are performed. Throughout this specification the terms “information” and “data” are used interchangeably, and may be substituted one for the other to obtain different embodiments.

In at least one embodiment, transaction terminal 110 may communicate with the mobile terminal, via various short-range wireless communication modes including, but not limited to, a Bluetooth communication mode, a Wi-Fi communication mode, an audio signal communication mode, and/or a Near Field Communication (NFC) mode. The Bluetooth communication mode may include at least a Bluetooth 2.0 mode and/or Bluetooth 4.0 mode (including Bluetooth Low Energy (BLE) mode). Near field communications may be used for performing transactions in order to enhance security, because fewer devices are likely to be close enough to intentionally receive other people's near field communications without being noticed. In at least one embodiment, when multiple communication modes are available to support the transmission of signals between the transaction terminal 110 and the mobile terminal, the transaction terminal 110 determines and/or chooses the optimal communication mode. In an embodiment, the optimal communication mode may be the safest and/or the fastest communication mode, and/or the communication mode that requires the least amount of data to be resent as a result of errors. In an embodiment, the operator of the transaction terminal 110 may set priorities and/or criteria for determining which communication mode to select (the operator of the transaction terminal 110 may be a system administrator and/or owner of the commercial establishment that transaction terminal 110 is associated with, for example). In an embodiment, if there is no communication mode that is both the fastest and the safest, the communication mode that is fastest is chosen. In an embodiment, if there is no communication mode that is both the fastest and the safest, the communication mode that is safest is chosen. In another embodiment a first score is assigned to the speeds of the different communication modes and a second score is assigned to the safety of the different communication modes, and the two scores are combined into a combined score. The communication modes with the highest combined score is chosen. For example, the two scores may be weighted and then added together to form a combined score. Alternatively, the product of the two scores or a product of a first power of the first score and a second power of the second score is used as the combined score, or the two scores may be combined in another way.

In at least one embodiment, the transaction terminal 110 conducts a test on the various communication modes that are available to the mobile terminal, in order to compare the strength of the signals of various modes, the speed of data transfer, and/or the safety settings of the various modes, for example. Then the transaction terminal 110 may rank the various modes of communication based on the test results, choose the optimal mode, thereby establishing a connection with the mobile terminal, and then implement transactions and/or promotional offers. In at least one embodiment, the transaction terminal 110 may communicate with various types of mobile terminals that have different technology and/or programs, which improves the versatility and flexibility of the transaction terminal 110, and enhances the user experience.

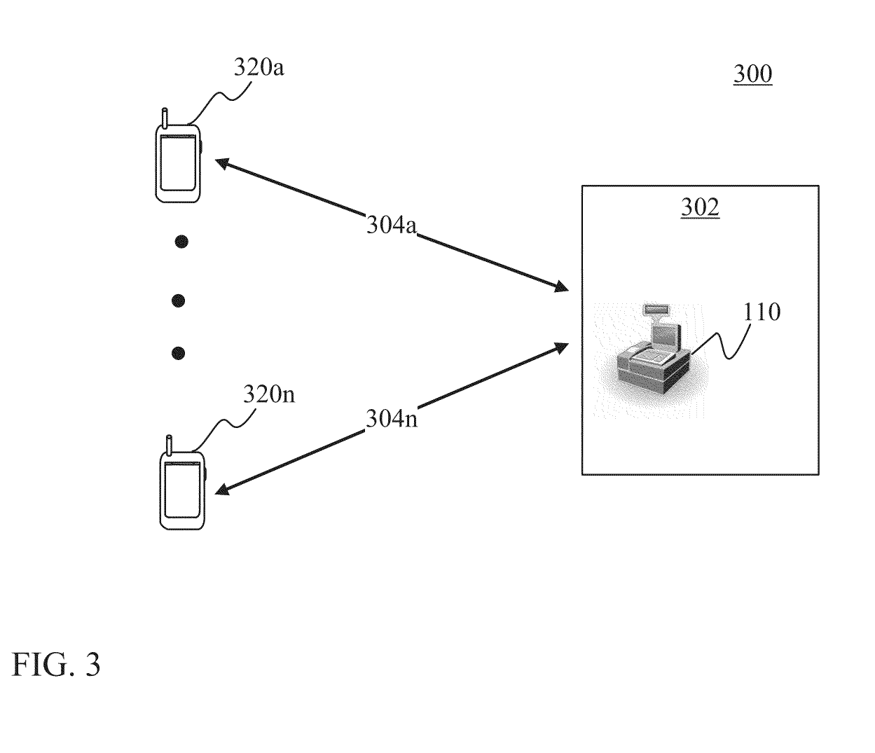

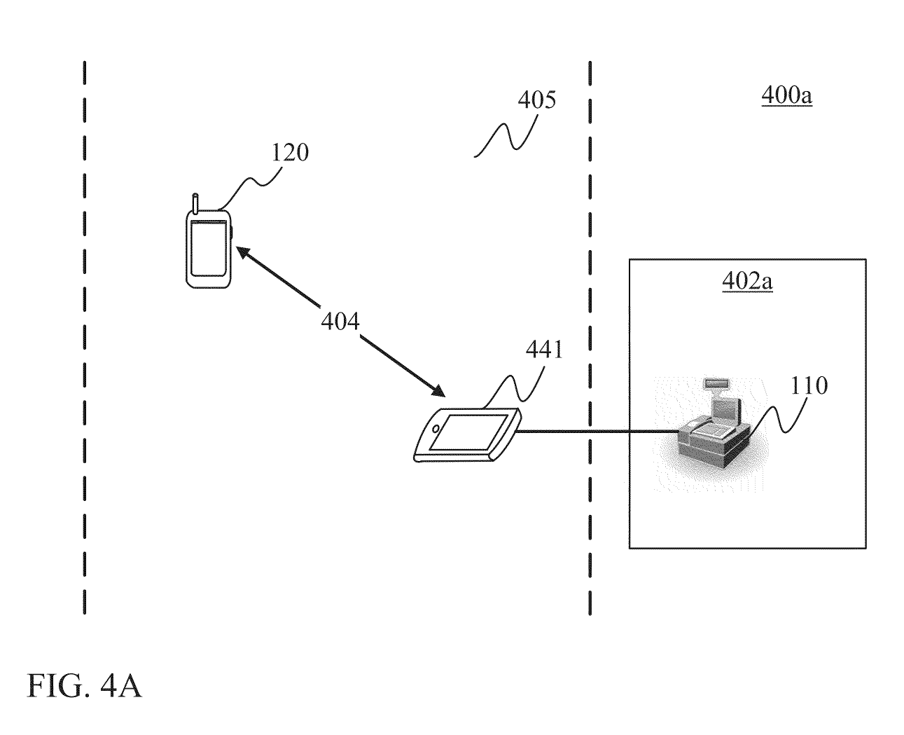

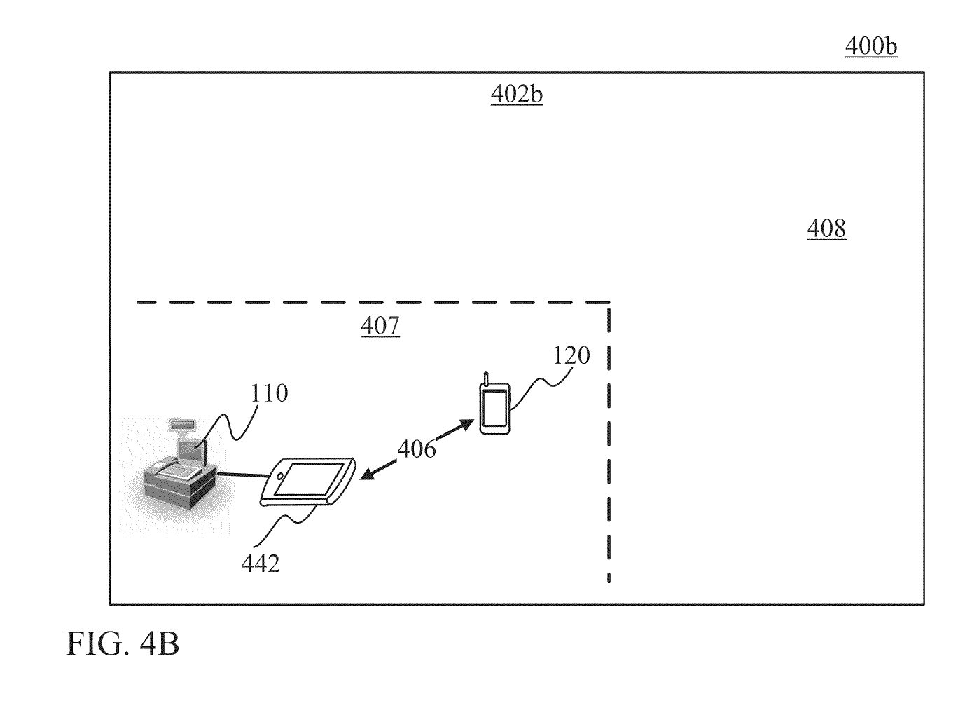

In at least one embodiment, the transaction terminal 110 communicates with mobile terminals that are within a preset region associated with the store. In at least one embodiment, the preset region may be a region that is within a preset distance (e.g., 1 meter, 5 meters, 50 meters, 200 meters, 400 meters) from the store and/or within a present distance of a region within the store. In at least one embodiment, system 100 may compare the position of the mobile terminal (e.g., the position information obtained by a GPS system of the mobile terminal) and the location of the store (e.g., the location information stored in the server about where the store is located) to determine whether the mobile terminal enters the preset region. In at least one embodiment, the transaction terminal 110 is connected to, or may include within itself, a presence detection device for detecting the presence of a mobile terminal that can communicate with the presence detection device via short-range communication. In at least one embodiment, the preset region may be the effective communication range of the presence detection device that is connected to or included in the transaction terminal 110. In at least one embodiment, the preset region of the store may be the region within which the mobile terminal is within a distance that is equal to or less than a predetermined distance from the store, from the presence detection device, and/or from the transaction terminal 110. The methods of detecting the presence of a mobile terminal within the preset region will be discussed in FIGS. 3, 4A, and 4B.

In at least one embodiment, after detecting of the presence of the mobile terminal in the preset region, the transaction terminal 110 communicates with the server, via public and/or private networks, to obtain information related to the customer associated with the mobile terminal. In at least one embodiment, the customer information may be retrieved from the database in the server. In at least one embodiment, the transaction terminal 110 also retrieves from the server, information related to online orders and/or information related to pickup orders of the customer. In at least one embodiment, the transaction terminal 110 displays customer information, transaction information, and/or pickup order information related to the customers that are within the preset region associated with the store. In another embodiment, the transaction terminal 110 displays information related to customers in the checkout area and/or customers that are close to the transaction terminal 110.

In at least one embodiment, when a mobile terminal enters the preset region, the transaction terminal 110 and/or the server transmits information to the mobile terminal. The transaction information that is transmitted may include transaction information, promotional offers, commercial advertisements, and/or invitations to games and/or other activities. In at least one embodiment, the transaction terminal 110 and/or the server transmit various information to get the customer's attention and attract the customer into the store to make purchases. For example, when the customer that is carrying a mobile phone enters the neighborhood of the store, the transaction terminal 110 and/or the server pushes advertisement and/or commercial information (e.g., on-going promotional discounts currently available in the store, and/or special prices of certain products) to the mobile terminal to attract the customer to come into the store. In another embodiment, while the mobile terminal is close to transaction terminal 110 (e.g., while the mobile terminal is in the checkout area), the transaction terminal 110 and/or the server sends transaction information, payment requests, and/or promotional offers to the mobile terminal. For example, when the customer finishes shopping and proceeds to the checkout area, the transaction terminal 110 and/or presence detection device may detect the presence of the mobile terminal and may send transaction data and/or a payment request. Then the transaction terminal 110 may receive the payment (e.g., the transaction terminal 110 may receive mobile payment and/or the transaction terminal 110 may receive a type of a payment that does not use a mobile device) and the transaction terminal 110 may execute the transaction. In yet another embodiment, the transaction terminal 110 and/or the server sends an invitation request to the mobile terminal, which invites the customer to interact with the system 100 (e.g., the customer may be invited to play simple games, to read a short story, to watch a video, to take a short quiz) so that the customer may get various coupons or gifts. In at least one embodiment, the transaction terminal 110 receives confirmations of the completions of the interactions (e.g., the scores the games or quizzes and/or an indication of whether the user passed the games or quizzes successfully, confirmation of finishing reading a story or watching a video) from the mobile terminal, and then the transaction terminal 110 issues coupons or vouchers for gifts to the mobile terminal, which are further stored on the mobile terminal. In at least one embodiment, the transaction terminal 110 may retrieve information about promotional offers that are related to the customer from the server. The transaction terminal 110 and/or the server may send messages to the mobile terminal of the customer for reminding and/or inviting the customer to redeem the available promotional offers. For example, the transaction terminal 110 or server may retrieve information, such information about available coupons or vouchers (e.g., vouchers for 10 cups of coffee, 5 burgers), and then the transaction terminal 110 or server sends a message to the mobile terminal to invite the customer to redeem the coupons and/or vouchers in the store, if appropriate. The customer may use the mobile terminal to communicate with the transaction terminal 110 to redeem the promotional offers that are stored on the mobile terminal. Alternatively, the customer may directly show the display of the mobile terminal to the store assistance and/or cashier, while the display is displaying the promotional offer.

In at least one embodiment, the customer may make a reservation or pickup order online or by phone, which is recorded on the mobile terminal and/or is recorded in an account associated with the customer. When the mobile terminal associated with the customer enters the preset region associated with the store, system 100 may retrieve the reservation and/or the order information to alert the store assistant to prepare the reserved and/or ordered items for the customer to pick up. Alternatively, the transaction terminal 110 may directly receive a pickup notice from the mobile terminal. In at least one embodiment, upon receiving the confirmation of the customer picking up the order, the system 100 issues promotional offers to the mobile terminal associated with the customer. In at least one embodiment, at checkout, the transaction terminal 110 and/or server 30 sends a request to select a method of payment to the mobile terminal. As a result, the mobile terminal may display, via a user interface, payment options for the customer to select. For example, the payment options may include paying by a mobile payment, debiting payment accounts, paying with a credit card/debit card, paying with stored promotional offers, or paying with other types of payment options. Information about the credit card/debit card may be stored on the mobile terminal to facilitate making a payment by the credit card/debit card, if the user chooses that form of payment.

In at least one embodiment, the transaction terminal 110 is connected to a Point of Sale (POS) machine or a retail terminal that includes a POS machine connected to a computer. The POS machine may be a smart cash register and/or other machine that performs the financial transaction. In at least one embodiment, the POS machine or the retail terminal sends information related to the transaction (e.g., a receipt, a consumption summary, a list of products purchased) to the transaction terminal 110. In at least one embodiment, the transaction terminal 110 may be part of the POS machine and/or the retail terminal. In at least one embodiment, the transaction terminal 110 may be connected to a retail system of a store. The retail system may, via short-range communication or other technologies, manage customer relationships, process payments, provide promotional offers to customers, and/or provide other services. In at least one embodiment, the transaction terminal 110 may be a terminal associated with the retail system of the store. The cashier may input consumption information, such as the prices and numbers of product purchased by the customer, into transaction terminal 110. In an embodiment in which the transaction terminal 110 is associated with the retail system of the store, the transaction terminal 110 calculates the total amount of the sale (or other transaction), and generates a receipt and/or a consumption list based on the input information by the cashier. Then, the transaction terminal 110 may send the consumption list and/or receipt to the mobile terminal, via the optimal communication mode selected. In at least one embodiment, the transaction terminal 110 may further calculate and/or determine the promotional offers that may be issued based on the current transaction, and may send information about the promotional offers to the mobile terminal. In at least one embodiment, the transaction terminal 110 may be fixed to, and/or installed on, the cashier counter or located in any of a number of other places. In another embodiment, the transaction terminal 110 may be a handheld device held by a cashier or shop assistant, whom may walk around in the store to assist people with transactions.

In at least one embodiment, the transaction terminal 110 communicates with the mobile terminal to process the payment via mobile payment and other payment types, and may issues promotional offers to the mobile terminal and/or updates information related to the transaction and promotional offers. In at least one embodiment, the effective communication distance between the transaction terminal 110 and the mobile terminal is 0.1 to 10 cm in order to transmit mobile payment signals and/or issuing promotional offers. In at least one embodiment, the transaction terminal 110 may include multiple devices and/or technologies, so as to support multiple types of payment. In at least one embodiment, the transaction terminal 110 may include any one of, some of, or all of the devices including a card reader/scanner, a Near Field Communication (NFC) device, a Wi-Fi device, a Bluetooth device (including Bluetooth 2.0 and/or Bluetooth 4.0), a microphone, a speaker, a camera, and/or a scanner. The card reader/scanner may read a magnetic stripe, a chip, and/or a smart card with embedded integrated circuits to complete a payment transaction. In one embodiment, the card reader/scanner uses one-way communication to retrieve payment information. In one embodiment, the NFC device may read mobile payment information from a mobile device that is equipped with NFC technology. For example, NFC device may process payment transactions using Google Wallet, Square Wallet, and/or payment accounts such as PayPal and/or Alipay on the mobile terminal of the customer. In at least one embodiment, the NFC device may interact with the mobile terminal in a two-way communication mode by processing payment transactions by accessing the mobile payment information on the mobile terminal, and by issuing promotional offers to the mobile terminal. In another embodiment, the NFC device may read contactless credit cards, debit cards, key fobs, and/or smartcards that have chips and/or antennas. The contactless credit cards, debit cards, key fobs, and/or smartcards may transmit (e.g., via a radio-frequency sound or electromagnetic signal) information for making secure payments (which may include one or more identifiers and/or security codes). For example, the NFC device of the transaction terminal 110 may read credit cards that have features such as Visa payWave, Master Card PayPass, and/or American Express ExpressPay. A Bluetooth low energy device (e.g., Bluetooth 4.0) as well as the microphone and/or speaker may also interact with the mobile terminal to retrieve mobile payment information to process payment and transmit information (e.g., consumption information, promotional offers) to the mobile terminal. The camera and/or scanner may read one-dimensional (1D), two-dimensional (2D) or three-dimensional (3D) barcodes, and/or encrypted barcodes displayed on the screen of the mobile terminal or printed on a gift card, a stored-value card, and/or on paper (e.g., a Starbucks stored-value card or a cash voucher).

In at least one embodiment, the transaction terminal 110 and/or another device that detects the presence of mobile devices may detect available mobile payment methods associated with the mobile terminal and display customer information and/or available payment methods on the transaction terminal 110, so that the store assistant may select the payment method and/or confirm the payment data to process the transaction. In at least one embodiment, the transaction terminal 110 displays instructions and/or information for store assistants to provide services such as order pickups, returns, and/or redemption of promotional offers.

In at least one embodiment, the transaction terminal 110, upon completing the payment transactions, issues promotional offers based on the consumption amount and/or other information (e.g., the promotional offers may be issued based on the customer ranking in a loyalty and/or membership program). In at least one embodiment, the transaction terminal 110 processes redemptions of promotional offers stored on the mobile terminal and/or in the loyalty and/or membership programs. In at least one embodiment, the transaction terminal 110 retrieves from the server and/or user account information about the available promotional offers, and sends confirmations to the customer that the promotional offers have been redeemed. In another embodiment, the transaction terminal 110 reads and/or scans promotional offers on the mobile terminal (or on membership cards or printed on paper) and updates the amount of the payment associated with the transaction. In another embodiment, the transaction terminal 110 reads and/or scans gift certificates or vouchers and indicates to the store assistant to prepare free gifts or to prepare other items based on the gift certificates and/or vouchers. The transaction terminal 110 then updates the number of remaining promotional offers in the user account or membership program associated with the customer. In at least one embodiment, the transaction terminal 110 may authenticate only the promotional offers that have a high value (e.g., a voucher or token of more than 100 dollars). For example, each coupon or token may be assigned with an authentication code (e.g., a serial number, or an encryption code). The transaction terminal 110 may communicate with the server for authentication of the coupon or token, and after redemption the redeemed coupon or token is recorded by the server to prevent reuse of the same coupon or token. In at least one embodiment, the transaction terminal 110 also supports vouchers for orders that have already been paid in full, have already been paid in part, and/or have not been paid. For example, when the customer wants to redeem a reservation voucher of a product (e.g., a product that has been selling particularly well), and the customer has not paid yet, then the transaction terminal 110 may process the process the reservation voucher by indicating to the store assistant to prepare the product for pickup (and optionally, transaction terminal 110 may also process the payment for the item).

Mobile terminal 120 is a mobile device used and/or owned by a customer that the customer uses for receiving, processing, storing, tracking, and/or managing transactions and/or promotional offers. Mobile terminal 120 is an embodiment of the mobile device mentioned above in conjunction with transaction terminal 110. Mobile terminal 120 may also have other uses, such as making phone calls, browsing a network, personal computing, and/or receiving messages. For example, the mobile terminal 120 may include smart phones, PDA (Personal Digital Assistant), tablet PCs, laptops, and/or other electronic mobile devices. In at least one embodiment, the mobile terminal 120 includes Apple iPhone, Apple iPod Touch, Apple iPad, Android phones, Android tablet PCs, RIM BlackBerry, Windows Phone, Nokia S60, and/or other mobile devices, which may be capable of running mobile applications. In at least one embodiment, the mobile terminal 120 includes wearable electronics or wearable devices, such as Google Goggles, Google Glasses, Apple iWatch, clothing or other accessories, that incorporate electronic technologies and optionally can run applications, etc. In at least one embodiment, the mobile terminal 120 is equipped with a communication module (e.g., a network interface) to communicate with a mobile communication network and/or other networks.

In at least one embodiment, the mobile terminal 120 stores personal information, mobile payment information, and/or promotional offers information associated with a customer in a memory system on mobile terminal 120 and/or in a user account, which may be stored in a memory system and/or server associated with the mobile service provider, payment service provider, and/or a server that manages system 100. In at least one embodiment, the mobile terminal 120 stores information and/or mobile applications related to various mobile payments and/or accounts. In at least one embodiment, the mobile terminal 120 receives transaction information from transaction terminal 110 with a request to pay for purchases made online or in store. In at least one embodiment, the customer makes the payment using either of the mobile payment types on the mobile terminal, or other types of payment methods that do not involve mobile terminal 120. In at least one embodiment, mobile terminal 120 stores and/or manages promotional offers that are received from the transaction terminal 110 and/or the server. In at least one embodiment, mobile terminal 120 receives commercial information, invitations, and/or other information from transaction terminal 110 and/or the server, when the mobile terminal enters a preset region associated with the store.

In at least one embodiment, the mobile terminal 120 may communicate with the server, via a mobile network or other networks. In an embodiment, the mobile terminal 120 may communicate with the server when the mobile terminal 120 is in an effective communication range of the transaction terminal 110 or other devices that are communicatively connected with the server. The devices connected with the server may include NFC devices, Bluetooth devices, Wi-Fi devices, and/or speakers and/or microphone for audio signal communication. In at least one embodiment, the mobile terminal 120 may communicate with the transaction terminal 110 and/or the presence detection device, via short-range communication.

In at least one embodiment, when the payment is processed using mobile payment on the mobile terminal 120, the system 100 may execute the payment transaction and issue promotional offers to the mobile terminal 120 synchronously. In another embodiment, when a payment is processed that does not involve the use of mobile terminal 120, the system 100 may issue promotional offers to the mobile terminal 120 after the payment is executed. For example, a customer may use E-wallets and/or electronic stored-value cards on mobile terminal 120 to process a payment, while the mobile terminal 120 also includes a mobile application of a membership program. When a payment transaction is executed, via mobile terminal 120, at the same time, promotional offers and/or membership credits may be received on the mobile terminal 120. In another example, when the customer makes a payment with cash, a check, a debit card, a credit card, or a stored-value card, for example, the system 100 may also issue promotional offers to the mobile terminal 120 of the customer if a user account is established on the mobile terminal 120. In other words, in case the payment method is not linked with a user account or membership account on the mobile terminal 120, the system 100 may issue promotional offers to the mobile terminal 120, which is communicatively connected to the transaction terminal 110 or the server. In at least one embodiment, system 100 supports any of the existing payment methods that may or may not involve the use of a mobile device.

In at least one embodiment, a mobile application is installed on the mobile terminal 120. In at least one embodiment, the mobile application includes a user interface for the customers to create, sign-in to, sign-out from, manage, and/or update a user account on the mobile terminal 120. In at least one embodiment, the user account may include personal information of the customer, transaction history, purchasing history, payment information, and/or programs for customers to receive, manage, and/or execute promotional offers. In at least one embodiment, the user account may be linked to mobile payment methods, credit card/debit card information, bank account, and/or other payment accounts. In at least one embodiment, the user account may be linked to accounts associated with various stores and/or websites, membership programs, loyalty programs, and/or social network accounts. In at least one embodiment, the user account may display information related to transactions, payment requests, promotional offers, advertisements, and/or invitations, which may be received from the transaction terminal 110, the server, and/or other devices. In at least one embodiment, the customer may log in to the user account on the mobile terminal 120 to update information, view advertisements, review transaction information, review payment requests, select a payment type, input payment information, review promotional offers, select promotional offers for redemption, accept invitations to play games, and/or perform other activities using the mobile terminal 120. In at least one embodiment, via mobile terminal 120, the customer may manually select postings on social networks, manually set postings on social networks, send pickup notices to the system 100, and/or receive promotional offers.

In at least one embodiment, the mobile application may send online order information, update online order information, send pickup information to the server and/or update pickup information to the server, and the server may further send the information to the transaction terminal 110 for the store assistant to prepare the pickup order. For example, after a customer placed an order online using a computer or a smart phone and chose to pick up the order in store, the order information is updated in the user account and/or in the server. When the mobile terminal 120 associated with the customer enters a preset region associated with the store (e.g., close to the store and/or transaction terminal 110), the mobile terminal 120 communicates with the server and sends a pickup notice, and as a result the server may send the pickup notice and the order information to the transaction terminal 110 to alert the store assistant to prepare the items in the order for pickup. Alternatively, the server and/or the presence detection device may detect the presence of the mobile terminal 120, and the server may retrieve the pickup order information and send the pickup order information to the transaction terminal 110. Alternatively, the mobile terminal 120 may directly communicate with the transaction terminal 110 to transmit the order pickup notice.

In at least one embodiment, the mobile terminal 120 may include and/or interact with a Global Positioning System (GPS) chip to obtain the present geographical position information of the mobile terminal 120. In at least one embodiment, the present geographical position information may include geographical position coordinates information (e.g., longitude, latitude, and altitude). In at least one embodiment, the mobile terminal 120 may include programs that interact with the built-in satellite positioning chip (or other GPS hardware), and, additionally or alternatively, may include indoor positioning programs and methods that produce the satellite positioning. In at least one embodiment, the mobile terminal 120 sends the present geographical position of the mobile terminal 120 to the server for determining whether the mobile terminal 120 has entered a preset region associated with the store (e.g., within 200 meters from the store). In at least one embodiment, the mobile terminal 120 sends the present geographical position and/or other information to the server, via mobile networks and/or other networks.

In at least one embodiment, the mobile terminal 120 includes programs and/or devices for monitoring and/or transmitting short-range communication signals. In at least one embodiment, the mobile terminal 120 includes Bluetooth devices for receiving and/or transmitting Bluetooth signals and/or Bluetooth low energy signals. In another embodiment, the mobile terminal 120 may include a Near Field Communication (NFC) device, and/or a Wi-Fi communication device. In yet another embodiment, the mobile terminal 120 may include a microphone and/or a speaker to monitor audio signals. In other embodiments, the mobile terminal 120 may include other types of receivers and/or transmitters. In at least one embodiment, transaction terminal 110 and/or presence detection device may transmit short-range communication signals that may include at least an identification code of the store where the transaction terminal 110 is installed. In at least one embodiment, the identification code may include numbers and/or letters. In at least one embodiment, the mobile terminal 120 receives the signal including the identification code when the mobile terminal 120 enters the preset region associated with the store (e.g., in the effective communication range of the transaction terminal 110 and/or presence detection device that sends the identification code). In at least one embodiment, the mobile terminal 120 may receive multiple types of short-range communication signals, each having the same identification code of the same store. In another embodiment, the mobile terminal 120 may receive various signals that are sent from different devices of multiple stores and/or may have different identification codes. For example, the mobile terminal 120 may be in a region close to multiple stores and thus may receive multiple signals having different identification codes for the stores. In at least one embodiment, the mobile terminal 120 may include a background daemon application that monitors short-range communication signals periodically (e.g., the daemon application continues to monitor the signals even when the user interface is not turned on).

In at least one embodiment, after receiving the short-range communication signal including the identification code, the mobile terminal 120, transmits signals including a confirmation message confirming the receipt of the identification code (which may be received by the transaction terminal 110 and/or presence detection device). In at least one embodiment, the mobile terminal 120 also transmits information related to the mobile terminal 120 (e.g., information about the user of the mobile terminal 120, user account, identifying the mobile terminal 120) along with the confirmation message. In another embodiment, after receiving the signal including the identification code, the mobile terminal 120 communicates with the server, via the mobile network or other networks, and sends the server a confirmation message that the mobile terminal 120 is within the preset region associated with the store. In at least one embodiment, after receiving the confirmation message from the mobile terminal 120, the server sends customer information to the transaction terminal 110 and requests the transaction terminal 110 to communicate with the mobile terminal 120 that is within the preset region associated with the store. In at least one embodiment, the mobile terminal 120 receives commercial information, advertisements, invitations to online games, and/or invitations for other activities from the server and/or transaction terminal 110 when entering the preset region associated with the store. In at least one embodiment, after receiving commercial information from the transaction terminal 110 and/or the server, the mobile terminal 120 stops sending the confirmation message (and therefore stops sending includes the identification code of the store). Therefore, mobile terminal 120 may only receive commercial information from the same store (e.g., once) as a result of the mobile terminal 120 enters the preset region, even if the mobile terminal 120 stays in the preset region associated with the store for a long time. In another embodiment, the mobile terminal 120 receives the same or different commercial information for limited times (e.g., twice, three times, four times) until the customer responds or confirms viewing the information. In yet another embodiment, the mobile terminal 120 may keep on receiving various information as long as the mobile terminal 120 stays within the preset region associated with the store (and the customer may also choose not to receive information on the mobile terminal 120). In yet another embodiment, the mobile terminal 120 may receive different information when entering different regions of the store. For example, the mobile terminal 120 may receive advertisements and/or on-going promotional information associated with the store when the mobile terminal 120 is on the street close to the store, while the mobile terminal 120 may receive transaction information and/or payment requests when the mobile terminal 120 is in the checkout area.

Server 130 is a server that stores, manages, and tracks customer information, promotional offers information, store information, and other data. In at least one embodiment, server 130 may communicate with the transaction terminal 110, mobile terminal 120, and/or the presence detect device, via public networks, private networks, wired networks, and/or wireless networks. Server 130 is an embodiment of the server mentioned above in conjunction with transaction terminal 110 and/or mobile terminal 120. In at least one embodiment, server 130 may communicate with the mobile terminal 120, via a mobile network. In at least one embodiment, server 130 communicates with the transaction terminal 110 and/or the presence detection device to provide customer information associated with the mobile terminal 120. In at least one embodiment, server 130 communicates with the mobile terminal 120 to determine whether the mobile terminal 120 is within a preset region associated with the store. In at least one embodiment, server 130 and/or transaction terminal 110 may send transaction information, commercial information, promotional offers, and/or other data to the mobile terminal 120 that is in a preset region associated with the store. In at least one embodiment, server 130 updates data in a memory system after a transaction is completed and/or after promotional offers are issued and/or redeemed.

In at least one embodiment, the server 130 includes in the memory system a customer database, a store database, and/or a promotional offers database. In at least one embodiment, the customer database may include information related to the customers, which may include, but is not limited to, name, sex, age, contact information, photographs, membership programs, rank in the membership programs, consumption information, payment methods, purchasing history, stored promotional offers, personal preferences, clicked advertisements, search history, education, current employer, places visited, search keywords, and/or social circles, for example. In at least one embodiment, the store database may include information related to the stores which may include, but is not limited to, store names, identification codes of stores, store locations, contact information of stores, store hours, websites of stores, advertisements related to the stores, promotion systems associated with stores, memberships offered by stores, current promotional offers, expired promotional offers, and/or different areas of the stores, for example. In at least one embodiment, the promotional offers database may include information related to the promotional offers, which may include, but is not limited to, promotional offers for different stores, types of promotional offers for different products, numbers of available promotional offers, the value of promotional offers, and/or the redeemed promotional offers, for example. In at least one embodiment, server 130 provides an interface to allow administrators to access the customer database, update the customer database, manage the customer database, access the store database, update the store database, manage the store database, access the promotional offers database, update the promotional offers database, and/or manage the promotional offers database. In at least one embodiment, server 130 provides an interface to allow administrators to access, update, and/or manage, all commercial information, various types of promotional offers, all types of interactions with customers, all the information about customers, information about stores, and/or transactions, for example. In at least one embodiment, server 130 provides an interface to allow administrators to manage stores.

In at least one embodiment, server 130 performs a test to determine whether the mobile terminal 120 is within a preset region associated with the store based on the present geographical position information received from the mobile terminal 120 and the store location information. In at least one embodiment, server 130 retrieves store location information from the store database, which may include geographical coordinates of the store (e.g., longitude, latitude, and altitude). In at least one embodiment, server 130 receives present geographical position information of the mobile terminal 120 from the mobile terminal 120, and calculates the distance between the present geographical position of the mobile terminal 120 and the store location. If the distance between the mobile terminal 120 and the store is equal to or less than a predetermined distance threshold (e.g., 200 meters, 100 meters, 10 meters), server 130 considers mobile devices 120 has passed the test and is assumed to be within the preset region. After a mobile device 120 is less than or at the predetermined distance threshold, server 130 may send a message to the transaction terminal 110. If the distance between the mobile terminal 120 and the store is more than the predetermined distance threshold, the server considers mobile terminal 120 to have failed the test and is not considered to be inside of the predetermined region. In at least one embodiment, the server 130 performs the test at a periodic set of times, e.g. every second, 10 seconds, minute, 10 minutes, hour, six hours, every day, and/or another time period. When the server 130 detects the presence of the mobile terminal 120 in the preset region, the server 130 and/or the transaction terminal 110 may transmit information to the mobile terminal 120 (e.g., once) and wait for a period of time (e.g., in 3 hours, 6 hours, one day, two days) until another test starts.

Presence detection device 140 is a device for detecting the presence of mobile terminal 120 in the preset region associated with the store. Presence detection device 140 is an embodiment of the presence detection device discussed in conjunction with transaction terminal 110, mobile terminal 120, and/or server 130. In at least one embodiment, presence detection device 140 is able to communicate with mobile terminals that are within the effective communication range using short-range communication technologies. In at least one embodiment, the presence detection device 140 may not establish connections with the mobile terminals that are outside the effective communication range of the presence detection device 140. In at least one embodiment, the presence detection device 140 and/or the mobile terminal 120 may include short-range communication technologies and/or devices, such as transmitters and/or receivers of Bluetooth signals (e.g., Bluetooth low energy signals), Wi-Fi signals, Near Field Communication (NFC) signals, audio signals, speakers and/or microphones. In at least one embodiment, the presence detection device 140 uses a single communication technology (e.g., Bluetooth low energy communication) and may communicate with mobile terminals that include the same technology (e.g., the latest models of smart phones equipped with Bluetooth low energy technology). In another embodiment, the presence detection device 140 includes various communication technologies and is able to communicate with various types of mobile terminals installed with various communication devices (e.g., both low-end and high-end smart phones).

In the embodiment of the presence detection device 140 being used to determine the presence of mobile terminal 120, the preset region falls within the effective communication range of the presence detection device 140. In one embodiment, the presence detection device 140 may be installed outside the store and/or on the street, while the preset region is a region around the store (e.g., within 200 meters from the store). In another embodiment, the presence detection device 140 may be installed on or close to the checkout counters, while the preset region may be a region near the checkout counters and only mobile terminals in the checkout area may be determined to be within the present region. In at least one embodiment, system 100 may include multiple presence detection devices that are installed in difference places inside and/or outside the store to detect presence of mobile devices in different preset regions. In at least one embodiment, the multiple presence detection devices may indicate which specific preset region the mobile terminal 120 enters. For example, a first presence detection device installed on the street outside the store may detect whether mobile terminal 120 is close to the store, so that the system 100 may send advertisements, discount information, and/or invitations to the mobile terminal 120 for attracting the customer into the store. While a second presence detection device installed on the checkout counter, near the checkout counter, and/or close to the transaction terminal 110. The second presence detection device may detect that mobile terminal 120 enters the checkout area, so that transaction information and/or payment request may be sent to the mobile terminal 120 for processing payments.

In at least one embodiment, the presence detection device 140 uses one or more communication methods and/or technologies to detect the presence of mobile terminal 120 in a preset region. In at least one embodiment, the presence detection device 140 periodically (e.g., every 1 second, 5 seconds, 1 minute, 5 minute, 30 minute) transmits signals using short-range communication technology. The short range signal of presence detection device 140 may include the identification code of the store. In at least one embodiment, only when the mobile terminal 120 is in the effective communication range (e.g., the preset region) of the presence detection device 140, would the mobile terminal 120 receive the identification code. When the mobile terminal 120 identifies signals that include an identification code of a store (which indicates the mobile terminal 120 enters the preset region), the mobile terminal 120 generates and sends a confirmation message to presence detection device 140, which may include the identification code of the store and/or information related to the mobile terminal 120. In at least one embodiment, the presence detection device 140 records the presence of the mobile terminal 120, and/or sends the record of presence and/or information related to the mobile terminal 120 to transaction terminal 110 and/or server 130. In at least one embodiment, based on the information received, the transaction terminal 110 and/or server 130 retrieves information related to the customer whom is associated with the mobile terminal 120 that enters the preset region. In at least one embodiment, the transaction terminal 110, server 130, and/or the presence detection device 140 push information (e.g., advertisements and/or promotional offers) to the mobile terminal 120, via the optimal communication mode determined by the transaction terminal 110. In at least one embodiment, the presence detection device 140 may be a standalone device. In another embodiment, the presence detection device 140 may be part of the transaction device 110, so that the transaction device 110 may detect the presence of mobile terminal 120. For example, when the transaction terminal 110 is able to transmit short-range communication signals including an identification code of the store, a presence detection device may not be necessary.

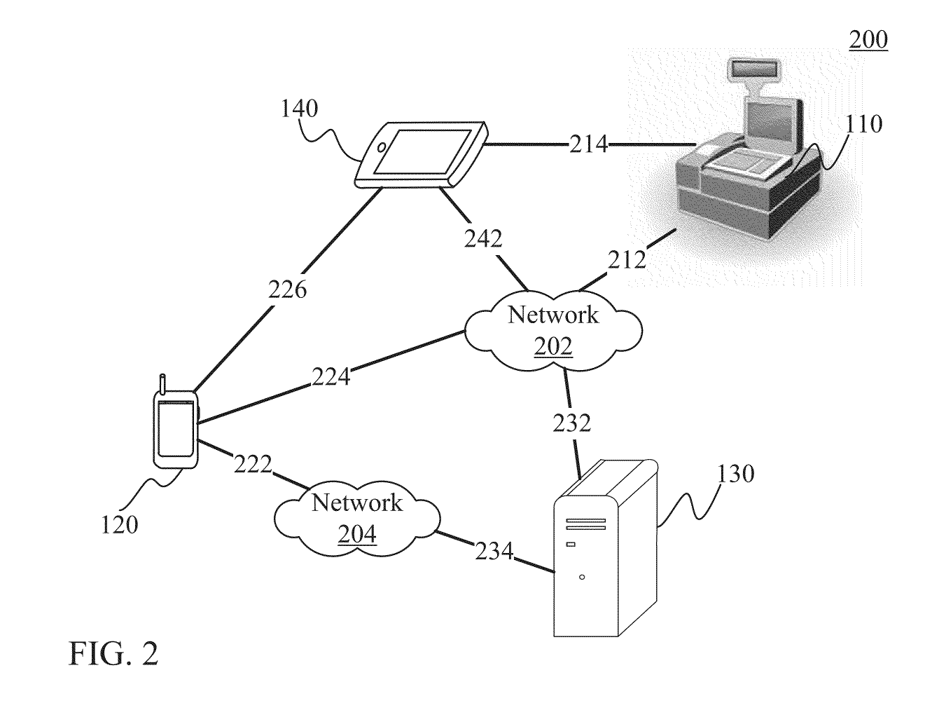

FIG. 2 shows a diagram 200 of another embodiment of the system 100 of FIG. 1. FIG. 2 includes transaction terminal 110, mobile terminal 120, server 130, and presence detection device 140, which were discussed in conjunction with FIG. 1. FIG. 2 further includes at least networks 202 and 204, and communication lines 212, 214, 222, 224, 226, 232, 234, and 242. In other embodiments, the system in FIG. 2 may not have all of the elements or features listed and/or may have other elements or features instead of, or in addition to, those listed.

FIG. 2 shows that the transaction terminal 110 and/or the presence detection device 140 may communicate with the server 130 via network 202. The mobile terminal 120 may communicate with the server via network 202, or alternatively via a mobile network 204. The presence detection device 140 may communicate with the transaction terminal 110, via wired or wireless connections. The presence detection device 140 and/or the transaction terminal 110 may communicate with the mobile terminal 120, via short-range communications when the mobile terminal 120 is in a preset region associated with the store.

Network 202 may be any combination of local area networks and/or wide area networks (e.g., the Internet). Network 202 may also include wireless phone networks and/or ordinary phone networks. The transaction terminal 110, the mobile terminal 120, and/or the presence detection device 140 can communicate with the server 130 via network 202. Optionally, the transaction terminal 110 can communicate with the mobile terminal 120 via network 202. In at least one embodiment, the presence detection device 140 and the transaction terminal 110 is communicatively connected, via a cable, wire and/or a wireless connection. In at least one embodiment, the mobile terminal 120 can communicate with the presence detection device 140 and/or the transaction terminal 110, via a short-range communication, in a two-way communication mode. The two-way communication mode allows the mobile terminal 120 to transmit information to the transaction terminal 110 and/or presence detection device 140, and vice versa.

Network 204 may be any combination of any mobile network, wireless phone networks, and/or ordinary phone networks. Alternatively or in addition to network 202, the mobile terminal 120 may communicate with the server 130 via network 204.

Communication line 212 communicatively links the transaction terminal 110 to the network 202 for transmitting signals between transaction terminal 110, server 130, mobile terminal 120, and/or presence detection device 140.

Communication line 214 communicatively links the transaction terminal 110 to the presence detection device 140 for transmitting signals between one another. Communication line 214 may include wired and/or wireless connections. In at least one embodiment, communication line 214 may include short-range communication. Communication line 214 is optional. The presence detection device 140 may be part of the transaction terminal 110 rather than be connected by communication line 214.

Communication line 222 communicatively links the mobile terminal 120 to the network 204 for transmitting signals between mobile terminal 120 and server 130. Communication line 222 is a wireless communication connection.

Communication line 224 communicatively links the mobile terminal 120 to the network 202 for transmitting signals between mobile terminal 120, server 130, and/or transaction terminal 110. Communication line 222 is a wireless or wired communication connection.

Communication line 226 communicatively links the mobile terminal 120 to the presence detection device 140 when the mobile terminal 120 is within the effective communication range of the presence detection device 140. In at least one embodiment, communication line 226 includes short-range communication. Communication line 226 is a wireless communication connection.

Communication line 232 communicatively links the server 130 to the network 202 for transmitting signals between server 130, mobile terminal 120, transaction terminal 110, and/or presence detection device 140. Communication line 222 is a wireless or wired communication connection.

Communication line 234 communicatively links the server 130 to the network 204 for transmitting signals between server 130 and mobile terminal 120 via a mobile network, for example. Communication line 222 is a wireless or wired communication connection.

Communication line 242 communicatively links the presence detection device 140 to the network 202. Communication line 242 is optional. communication line 242 may be a wired and/or wireless communication line. After detection of the presence of the mobile terminal 120, the presence detection device 140, send, via communication line 242, send the detection results, through network 202, to the server 130, or may send the detection result to the transaction terminal 110 so that the transaction terminal 110 may send to the server 130 via network 202.

FIG. 3 shows a diagram 300 of an embodiment of presence of mobile terminals in a preset region of a store. FIG. 3 shows at least transaction terminal 110 and mobile terminals 320a-n. FIG. 3 also shows a store 302 and distances 304a-n. In other embodiments, FIG. 3 may not have all of the elements or features listed and/or may have other elements or features instead of, or in addition to, those listed.

FIG. 3 shows that the preset region may be outside of the distance between the mobile terminal and the store and may be used to determine whether the mobile terminal is within predetermined distances from the preset region. In FIG. 3, each mobile terminal is in a distance from the store, which distance may be used to determine whether the mobile terminal is in the preset region associated with the store. The preset region may have any shape. In an embodiment, the present region may be a circular region defined by a radius from the presence detection device 140 and/or from the center of the store. In an embodiment, the preset region is a rectangular region, and the GPS coordinates of the corners of the region may define the region.

Store 302 offers various products and/or services. Store 302 may include at least a transaction terminal 110 and/or checkout devices for customers to pay for the products and/or services. In at least one embodiment, store 302 is in a building on the side of a street. In another embodiment, store 302 is in one or more rooms inside a building by an aisle.

Mobile terminals 320a-n may be similar to any of the mobile terminals discussed in conjunction with the mobile terminal 120 of FIG. 1. In at least one embodiment, mobile terminals 320a-n may include various types of mobile devices carried by different customers. In one embodiment, the customers who carry mobile terminals 320a-n may walk on a street or aisle outside the store 302.

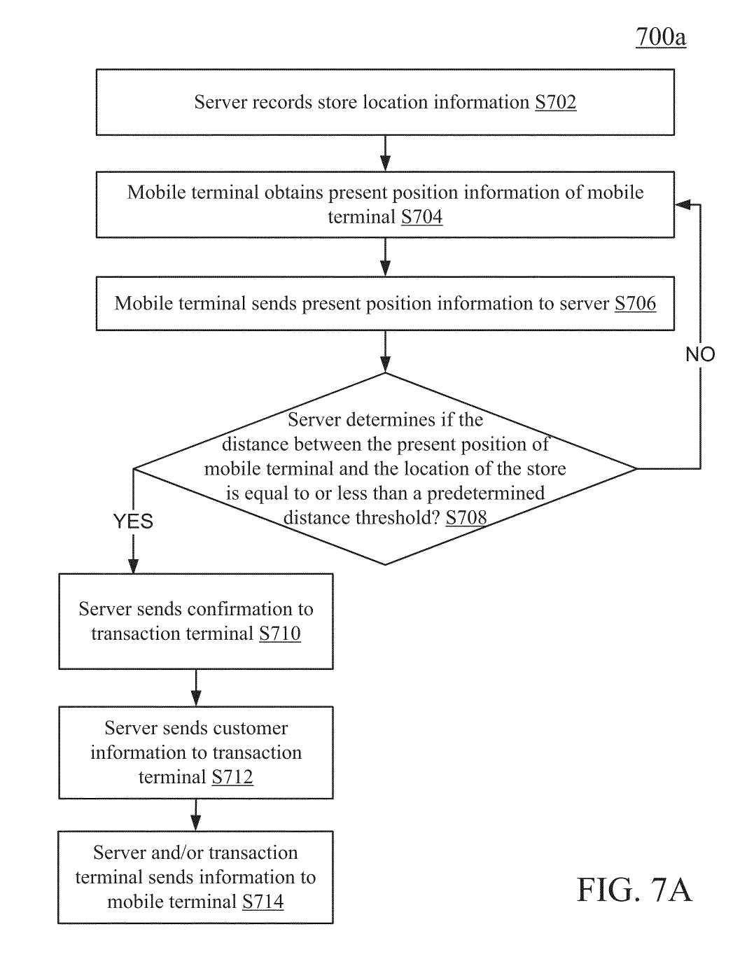

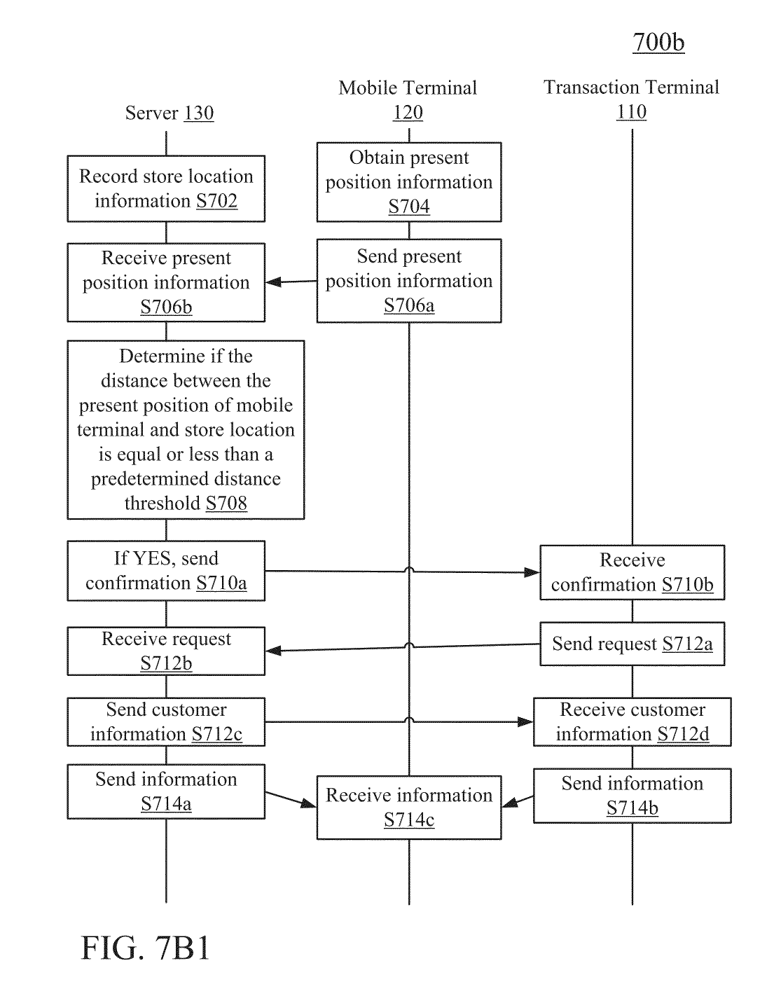

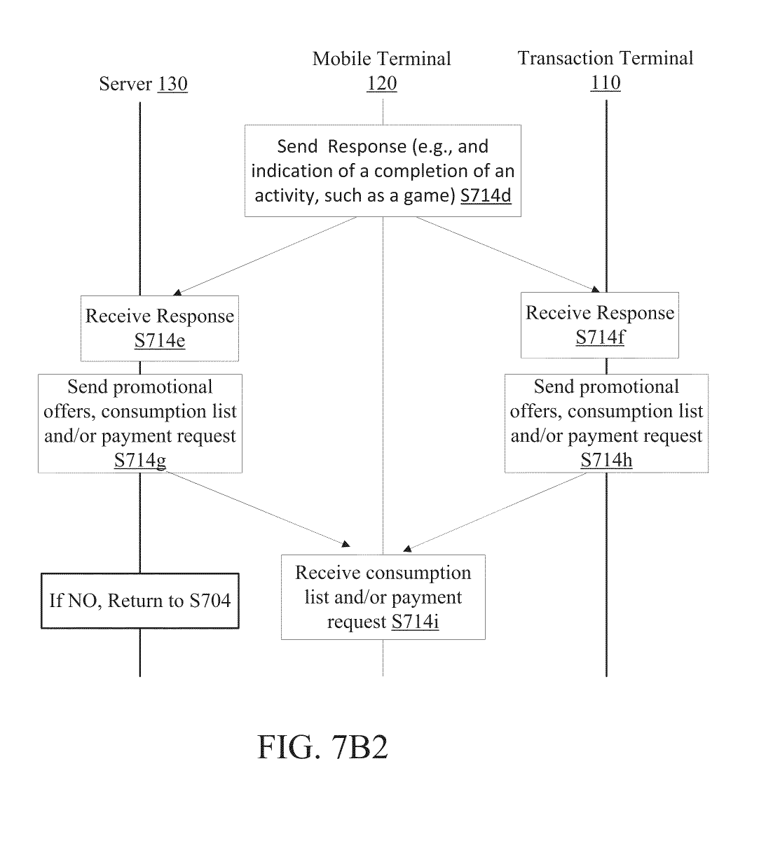

Distances 304a-n are distances between the store 302 and the mobile terminals 320a-n, respectively. In at least one embodiment, distances 304a-n refers to the distances calculated using the coordinates of the store and the mobile terminals 320a-n, respectively. In at least one embodiment, each of the mobile terminals 320a-n obtains the present geographic position information and transmits the information to the server 130, and the server 130 compares the presence geographic position of the mobile terminals 320a-n and the store location to determine the distances 304a-n, respectively. The methods and steps will be discussed in FIGS. 7A and 7B.

FIG. 4A shows a diagram 400a of an embodiment of the system including the presence detection device placed outside the store. FIG. 4A shows at least transaction terminal 110, mobile terminal 120, and a presence detection device 441. FIG. 4A also shows a store 402a, a distance 404, and a street 405. In other embodiments, FIG. 4A may not have all of the elements or features listed and/or may have other elements or features instead of, or in addition to, those listed.

FIG. 4A shows an example of system in which the presence detection device is located outside the store and may detect the presence of mobile terminal 120 in the neighborhood of the store.

Store 402a may be an embodiment of store 302. Store 402a includes a transaction terminal 110 that is communicatively connected with a presence detection device installed outside the store 402a. In the example of FIG. 4, store 402 is in a building on the side of a street.

Distance 404 is the distance between mobile terminal 120 and the presence detection device that is installed outside the store 402a. In at least one embodiment, when distance 404 is less than a predetermined distance, the mobile terminal 120 may receive short-range communication signals (and/or long term communication signals) from the presence detection device.

Street 405 is a street outside the store 402a. Street 405 may have other stores along the street 405. Street 405 may include various structures for attaching the presence detection device, such as curbs, poles, trees, advertisement boards, and/or seats.

Presence detection device 441 is an embodiment of the presence detection device 140 as discussed in conjunction with FIG. 1.

In at least one embodiment, presence detection device 441 is installed on the door or exterior wall of the store 402a facing the street 405, or on the street 405. In at least one embodiment, the presence detection device 441 detects the presence of mobile terminals in a larger area around the store (e.g., on the street 405 close to the store), via short-range communications. (e.g., once) a mobile terminal 120 is close to the store, the transaction terminal 120, server 130, and/or presence detection device 441 may transmit information to the mobile terminals for attracting customers into the store 402a. In at least one embodiment, the presence detection device 441 may use a combination of various communication technologies for communicating with various mobile terminals that may enter the effective communication range of the presence detection device 441.

In at least one embodiment, the presence detection device 441 installed outdoors may include a built-in battery and/or use technologies with low energy consumption so as to work for a longer time. For example, the presence detection device 441 may include a Bluetooth low energy transmitter with a build-in battery, which can transmit signals continuously for two years. In another example, the presence detection device 441 may have a built-in battery and include NFC transmitter and/or receiver with low energy consumption. In yet another example, the presence detection device 441 may have a built-in battery and include speaker and/or microphone for audio signals with low energy consumption. In at least one embodiment, the presence detection device 441 may be installed in places at a distance from the store where no power outlet is available. Therefore, a wider region around the store may be defined, in which the system 100 may send information to mobile terminals and/or invite the customers associated with the mobile terminals to enter the store. In another embodiment, the presence detection device 441 may be installed inside the store or in places where a power supply is available to power the presence detection device 441. In at least one embodiment, the presence detection device 441 may include any one of, some of, or all of the communication devices and/or technologies mentioned in the specification.

FIG. 4B shows a diagram 400b of an embodiment of the system including the presence detection device placed inside the store and close to the transaction terminal 110. FIG. 4B shows at least transaction terminal 110, mobile terminal 120, and a presence detection device 442. FIG. 4B also shows a store 402b, a distance 406, a checkout area 407, and a retail area 408. In other embodiments, FIG. 4B may not have all of the elements or features listed and/or may have other elements or features instead of, or in addition to, those listed.

FIG. 4B shows that the presence detection device may be installed close to the transaction terminal 110 in the checkout area of the store, so that the preset region defined by the presence detection device may be in the checkout area. In at least one embodiment, when the presence detection device detects that the mobile terminal 120 enters the checkout area, the presence detection device and/or the transaction terminal 110 may send transaction information and/or payment request to the mobile terminal 120 to initiate a payment process. The presence detection device and/or the transaction terminal 110, after the completion of the payment transaction, may also issue promotional offers to the mobile terminal 120 within the checkout area.

Store 402b is similar to and may be an embodiment of store 302 and/or store 402a. Store 402b includes a transaction terminal 110 in a checkout area and a presence detection device that is installed close to the transaction terminal 110. Store 402b may also include a retail area.

Distance 406 is the distance between the mobile terminal 120 and the presence detection device. In at least one embodiment, the mobile terminal 120 may receive signals from the presence detection device when the distance 406 is less than a predetermined distance.

Checkout area 407 is an area where checkouts and payments are processed. Checkout area 407 may include checkout counters and/or machines for cashier-staffed checkout and/or self checkout. In at least one embodiment, the transaction terminal 110 and/or presence detection device is installed in the checkout area (e.g., close to or on the checkout counters). In at least one embodiment, the checkout area 407 may be in any location inside the store 402b (e.g., in the corner, along one side, or in the middle). In at least one embodiment, store 402b may include more than one checkout areas and/or more than one transaction terminals. In at least one embodiment, after picking up items and/or placing online orders, the customers proceed to the checkout area to complete payment transactions and/or pickup. In another embodiment, a transaction may be processed when in other areas of the store 402b.

Retail area 408 is an area where items and/or products are located. In at least one embodiment, retail area 408 includes rows of selves that store items for sale. In at least one embodiment, customers may pick up items in the retail area 408, and then proceed to checkout in the checkout area 407.

Presence detection device 442 may be similar to and/or an embodiment of the presence detection device 140, discussed in conjunction with FIG. 1. In at least one embodiment, presence detection device 442 may be installed and/or placed near the transaction terminal 110. In at least one embodiment, the presence detection device 442 may be installed on or close to the checkout counters for detecting the mobile terminals in the checkout area (e.g., when the customers are ready to pay for or pick up an order). In at least one embodiment, the presence detection device 442 and/or the transaction terminal 110 only detects and/or displays information related to the customers in the checkout area and/or near the transaction terminal 110. In at least one embodiment, the presence detection device 442 may be part of the transaction terminal 110, so that the transaction terminal 110 may detect the mobile terminals within a preset region close to the transaction terminal 110 (e.g., within effective communication range of the transaction terminal 110). In one embodiment of the transaction terminal 110 including a presence detection device, the transaction terminal 110 may be a handheld device carried by a shop assistant whom walks around in the store, and may display information about the mobile terminals close to the shop assistant. In an embodiment in which the presence detection device 442 is a handheld device, the transaction terminal 110 carried by the shop assistant may communicate with mobile terminals close to the shop assistant, via the optimal communication mode to implement transactions and/or promotional offers. Presences detection device 442 (as well as presence detection device 140) does not need to be located within the preset region, but could be located outside of the preset region as long as presence detection device 442 (or 140) is capable of detecting whether mobile device 120 is within the preset region.

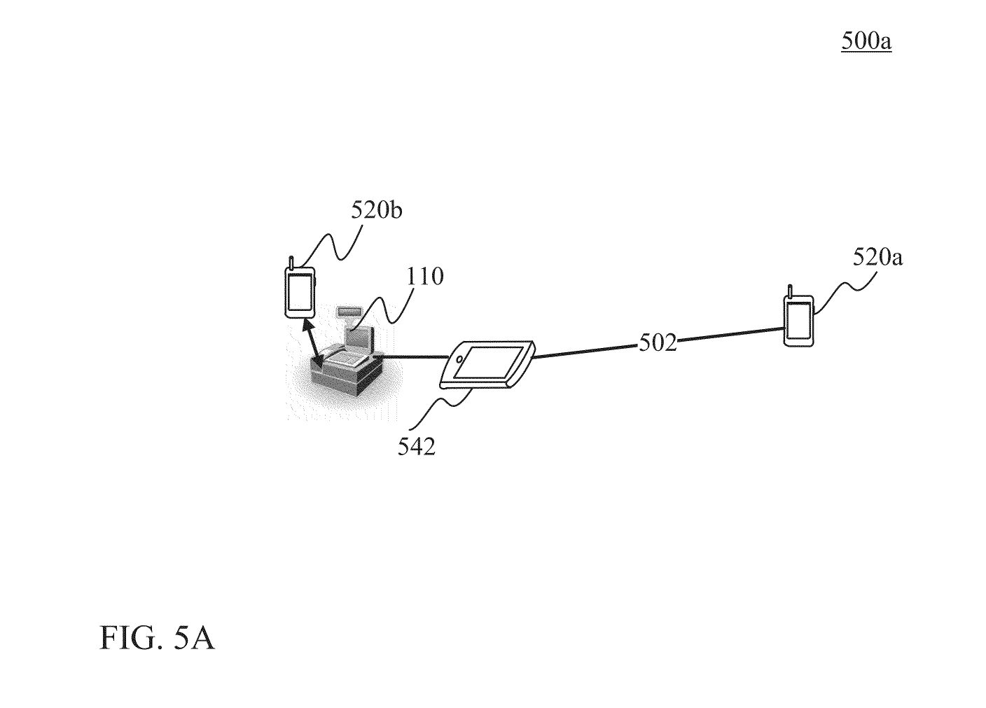

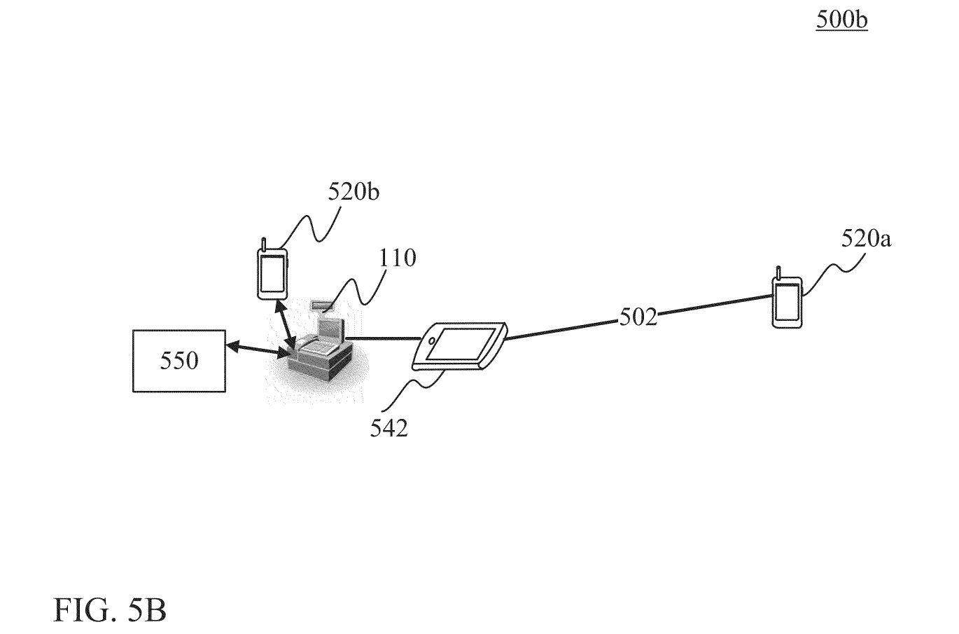

FIG. 5A shows a diagram 500a of an embodiment of the system processing transactions using mobile payment methods and issuing promotional offers synchronously on the mobile terminal 110. FIG. 5A shows at least transaction terminal 110, mobile terminals 520a and 520b, presence detection device 542, and connection 502. In other embodiments, FIG. 5A may not have all of the elements or features listed and/or may have other elements or features instead of, or in addition to, those listed.

FIG. 5A shows that mobile terminals may be used to process mobile payment and receive promotional offers synchronously. In FIG. 5A, the transaction terminal 110 and/or the presence detection device communicates with the mobile terminals within the preset region associated with the store, via the optimal communication mode. The mobile terminal may be activated, or may be moved close to the transaction terminal 110, to transmit payment signals and receive promotional offers that are issued based on the payment transaction. In this specification, the term activated is generic to tapped, swiped, clicking on a touch pad, pressing a key, touching a touch screen, and rolling a roll ball, for example. The terms tapped, swiped, clicking on a touch pad, pressing a key, touching a touch screen, and rolling a roll ball may be substituted for the word “activated” in any place that the term activated occurs to obtain specific embodiments.

Mobile terminals 520a and 520b are customer operated mobile terminals and maybe similar to and may be embodiments of the mobile terminal 120. Mobile terminals 520a and 520b may be two different mobile terminals or may be the same mobile terminal, but in different locations of FIG. 5A. When the mobile terminal 520a is close to the presence detection device, which is linked to the transaction terminal 110. The transaction terminal 110 and/or the presence detection device sends transaction information and/or payment request via the optimal communication mode to the mobile terminals 520a. Then the mobile terminal 520a may be activated or moved close to the transaction terminal 110 (as shown in mobile terminal 520b of FIG. 5A), so that payment signals may be transmitted to the transaction terminal 110. Meanwhile the transaction terminal 110 may issue promotional offers to the mobile terminal 120. In at least one embodiment of mobile payment being used, the execution of payment and the issuance of promotional offers may be completed in only one step on the mobile terminal 520b.

Presence detection device 542 is similar to, and may be an embodiment of presence detection device 442 of FIG. 4B for detecting mobile terminals within a preset region close to the presence detection device 542.

Connection 502 communicatively connects the presence detection device 542 (and/or the transaction terminal 110), via the optimal communication mode. In at least one embodiment, connection 502 includes short-range communication. The communications and the optimal mode are discussed in conjunction with FIG. 1, which are used in the example of FIG. 5A.

FIG. 5B shows a diagram 500b of an embodiment of the system processing transactions using payment types other than mobile payments and issuing promotional offers on the mobile terminal. FIG. 5B shows at least transaction terminal 110, mobile terminals 520a and 520b, presence detection device 542, connection 502, and payment 550. In other embodiments, FIG. 5B may not have all of the elements or features listed and/or may have other elements or features instead of, or in addition to, those listed.

FIG. 5B shows that transaction terminal 110 accepts other types of payment that do not involve the use of a mobile terminal. Upon the completion of payment transaction, the transaction terminal 110 may issue promotional offers to the mobile terminal. In at least one embodiment, the payment transaction and the issuance of promotional offers are carried out in separate steps.

Payment 550 may include any of the payment types that do not use mobile terminal 120. In at least one embodiment, payment 550 may include any of cash, a check, and physical forms of a credit/debit card, a stored-value card, a gift card, and/or a voucher. In at least one embodiment, payment 550 may include a magnetic strip, a chip, a barcode, and/or a series number, which can be read and/or scanned by a card reader, scanner, and/or camera of the transaction terminal 110 for processing a payment. In another embodiment, payment 550 may include physical forms of credit cards and/or stored value cards that include NFC technology (e.g., Visa payWave, MasterCard PayPass, AmericanExpress Expresspay). In at least one embodiment, as part of payment 550, the customer may pat a device, insert a device into terminal 110, and/or slide a device into transaction terminal 110, or may move the device for making payment 550 close to transaction terminal 110, so that the transaction terminal 110 may read and/or retrieve the information of the payment 550. In another embodiment, the customer may hand a device for making the payment 550 to the store assistant to process the payment. For example, the customer may give cash, checks, and/or vouchers to the store assistant, so that the store assistant may input the payment information using the transaction terminal 110. For example, a credit card may be read to make a payment, and in the next step the mobile terminal 520b may be activated or moved close to the transaction terminal 110 to receive promotional offers.

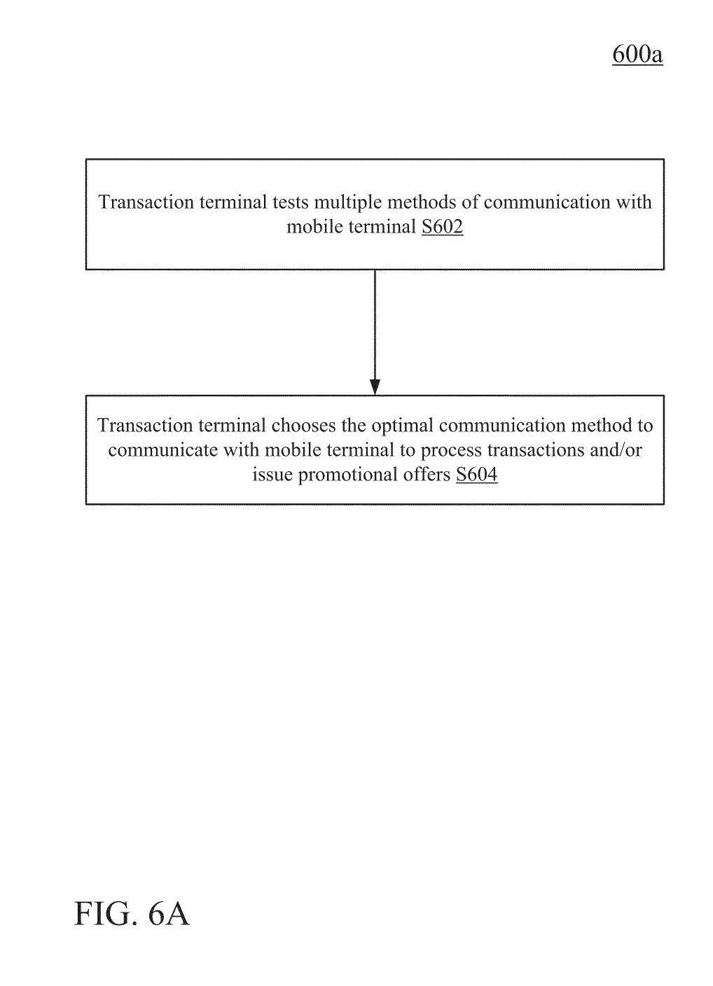

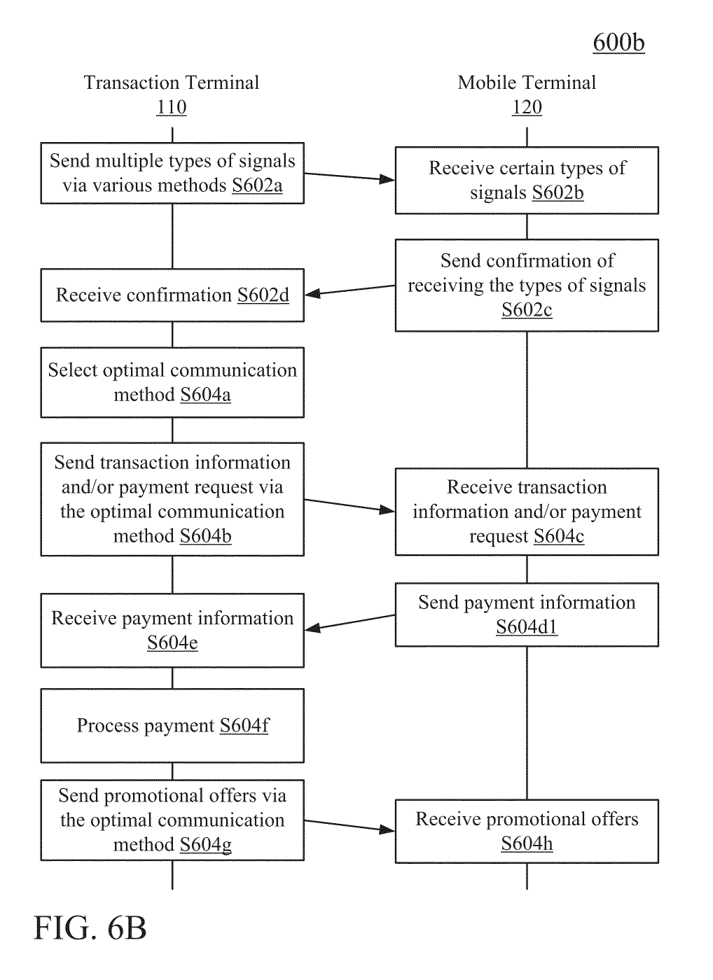

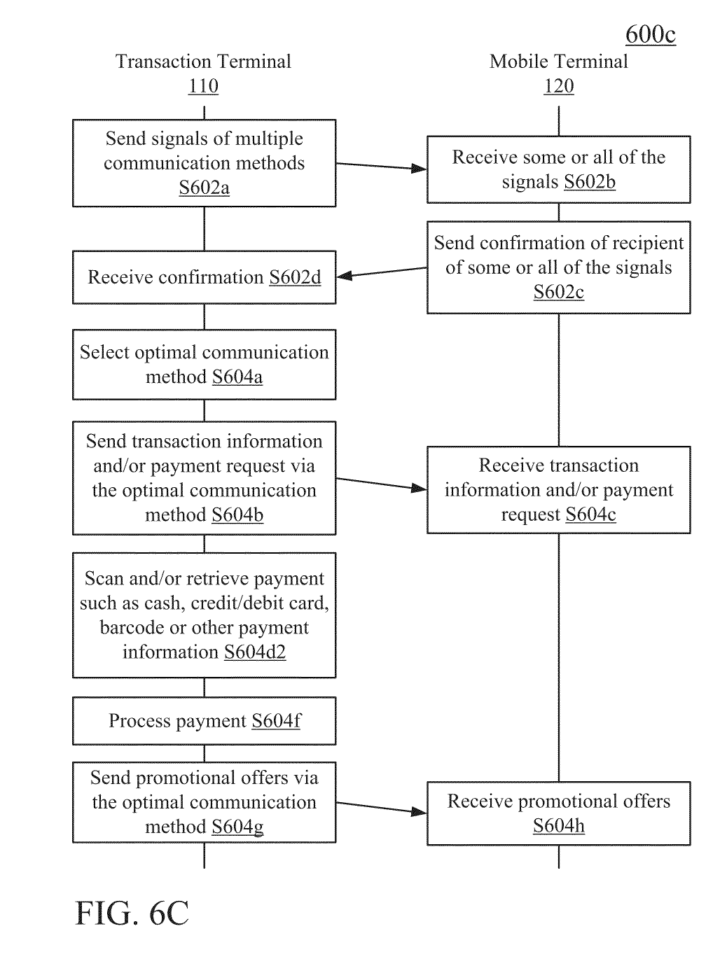

FIGS. 6A-C are flowcharts of an embodiment of a method 600 of implementing transactions and/or promotional offers. FIGS. 6B and 6C divide the steps of FIG. 6A into sub-steps showing which machine performs which sub-steps. The sub-steps and steps performed by a given machine may be considered steps of the method performed by that machine. In other words, FIG. 6B shows at least two methods—one that is performed by transaction terminal 110 and one that is performed by mobile terminal 120. Similarly, FIG. 6C shows at least two methods—one that is performed by transaction terminal 110 and one that is performed by mobile terminal 120 and/or another device for making the payment. The methods of FIGS. 6B and 6C are two different embodiments of the method of FIG. 6A. FIG. 6B is an embodiment of FIG. 6A using a mobile terminal 120 to make a payment. FIG. 6C is an embodiment of FIG. 6A using a payment is made without a mobile device.

In step S602 (FIG. 6A), transaction terminal 110 tests multiple methods of communication with the mobile terminal 120. Step S602 (FIG. 6A) includes sub-steps S602a-S602d (FIGS. 6B and 6C). In sub-step S602a (FIGS. 6B and 6C), the transaction terminal 110 sends signals, via multiple methods of communication. In at least one embodiment, the signals are sent via short-range communication, which was discussed in conjunction with FIG. 1. In sub-step S602b (FIGS. 6B and 6C), the mobile terminal 120 may receive one type of, some types of, or all types of signals sent by the transaction terminal 110. In sub-step S602c (FIGS. 6B and 6C), the mobile terminal 120 sends confirmation messages of receiving the signals. The confirmation messages may be received by the transaction terminal 110 in sub-step S602d (FIGS. 6B and 6C). Optionally, before step S602 (FIG. 6A), the transaction terminal 110 may calculate the transaction amount and generate a consumption list and/or a receipt based on consumption information. Optionally, promotional offers that may be issued based on the consumption information may also be calculated and/or generated by transaction terminal 110.

In step S604 (FIG. 6A), the transaction terminal 110 chooses the optimal communication method to communicate with mobile terminal 120 to process transactions and/or issue promotional offers. Step S604 (FIG. 6A) may include sub-steps S604a-S604d2 (FIGS. 6B and 6C).

In sub-step S604a (FIGS. 6B and 6C), the transaction terminal 110 compares the communication methods that were confirmed by the mobile terminal 120, and select the optimal communication mode to establish a connection with the mobile terminal 120. The methods to determine the optimal communication mode were discussed in conjunction with FIG. 1.

In sub-step S604b (FIGS. 6B and 6C), the transaction terminal 110 sends transaction information and/or payment request to the mobile terminal 120, via the optimal communication mode. Optionally, the transaction information may include the consumption list and/or receipt generated by the transaction terminal 110. Alternatively or additionally, the transaction terminal 110 may send commercial information and/or invitations to the mobile terminal 120, via the optimal communication mode.

In sub-step S604c (FIGS. 6B and 6C), the mobile terminal 120 receives the transaction information and/or payment request. Optionally in sub-step S604c, the mobile terminal 120 also receives other commercial information and/or invitations.

In sub-step S604d1 (FIG. 6B), the mobile terminal 120 sends payment information to the transaction terminal 110. As part of sub-step S604d1 (FIG. 6B), the mobile terminal 120 may display the transaction information and/or payment options for the customer to select from available payment methods (e.g., mobile payment, E-wallet, online payment, account). As part of sub-step S604d1, the customer may select payment method on the mobile terminal 120 and/or confirm processing the payment. As part of sub-step S604d1, the mobile terminal 120 may be activated or moved close to (e.g., less than 10 cm from) the transaction terminal 110 so that the payment signals (e.g., NFC signals, Bluetooth low-energy signals, audio signals) of the mobile terminal 120 may be received by the transaction terminal 110.

In sub-step S604e (FIG. 6B), the transaction terminal 110 receives the signals including payment data from the mobile terminal 120. In at least one embodiment, the transaction terminal 110 may include a NFC device, Bluetooth low energy device, speaker and/or microphone to retrieve payment information from the mobile terminal 120.

In sub-step S604f (FIGS. 6B and 6C), the transaction terminal 110 processes the transaction using the payment data received. Optionally, as part of sub-step S604f, the transaction terminal 110 displays customer data and/or payment data for the store assistant to confirm and complete the payment transaction. As part of sub-step S604f, the transaction terminal 110 may interact with the retail system of the store, and record and/or update the inventory and transaction. As part of sub-step S604f, the transaction terminal 110 may interact with servers or gateways of the payment method to process the transaction.

In sub-step S604g (FIGS. 6B and 6C), the transaction terminal 110 issues promotional offers to the mobile terminal 120 based on the transaction information. As part of sub-step S604g (or before step S602), the transaction terminal 110 may calculate and/or generate promotional offer information based on the transaction, the ranking of the customer in membership programs, and/or the rules of issuing promotional offers. As part of sub-step S604g, the transaction terminal 110 may communicate with the server 130 to update the information of transaction and/or promotional offers.

In sub-step S604h (FIGS. 6B and 6C), the mobile terminal 120 receives the promotional offer information, and stores and/or updates the information in the memory or the user account on the mobile terminal 120. In at least one embodiment, the mobile terminal 120 may be activated, or moved close to the transaction terminal 110, to complete a payment transaction and/or to receive promotional offers. In at least one embodiment, the mobile terminal 120 only needed to be activated, or moved close to the transaction terminal (e.g., once), to transmit the payment signal and receive promotional offer information.

FIG. 6C shows that the transaction terminal 110 may accept payment types that do not use the mobile terminal 120. After the mobile terminal 120 receives transaction information from the transaction terminal 110 in sub-step S604c, instead of implementing sub-step S604d1 (FIG. 6B), using mobile payment the customer may decide to implement step S604d2 (FIG. 6C) and use other payment methods (e.g., cash, check, physical forms of credit card, debit card, gift card, stored-value card). In sub-step S604d2, the transaction terminal 110 may use a card reader, a scanner, a and/or camera to read, scan, and/or retrieve payment information from credit cards, debit cards, gift cards, stored-value cards, barcodes, checks, and/or vouchers. In another embodiment, transaction terminal 110 may receive input information from a store assistant when the store assistant receives cash or other payment directly from the customer. The payment types that do not involve mobile terminal 120 were discussed in conjunction with payment 550 of FIG. 5B.

Then, in sub-step S604f, the transaction terminal 110 processes the payment using the payment information received in sub-step S604d2. In sub-steps S604g and S604h, the transaction terminal 110 transmits promotional offers to the mobile terminal 120 associated with the customer via optimal communication mode. Optionally, in sub-steps S604g and S604h, the mobile terminal 120 needs to be activated or moved close to the transaction terminal 110 to receive the promotional offer information.

In an embodiment, each of the steps of method 600 is a distinct step. In at least one embodiment, although depicted as distinct steps in FIGS. 6A-C, steps S602-S604 may not be distinct steps. In other embodiments, method 600 may not have all of the above steps and/or may have other steps in addition to or instead of those listed above. The steps of method 600 may be performed in another order. Subsets of the steps listed above as part of method 600 may be used to form their own method.

FIGS. 7A, 7B1, and 7B2 are flowcharts of an embodiment of a method 700 of determining whether the mobile terminal 120 is present in the preset region associated with the store. The flowchart of FIG. 7B2 is a continuation of the flowchart of FIG. 7B1. The flowchart of FIGS. 7B 1 and 7B2 divide the steps of FIG. 7A into sub-steps showing which machine performs which sub-steps. The sub-steps and steps performed by a given machine may be considered steps of the method performed by that machine. In other words, FIGS. 7B1 and 7B2 show at least three methods—one that is performed by transaction terminal 110, one that is performed by mobile terminal 120, and one that is performed by server 130. In method 700, the location of the mobile terminal 120 and whether mobile terminal is within the preset region is determined without necessarily using of presence detection device 140.

In step S702, the server 130 records information of store location, which may be stored in the store database in the memory system of server 130.

In step S704 (FIG. 7A), the mobile terminal 120 interacts with the GPS system installed on the mobile terminal 120 to determine the present position of the mobile terminal. In at least one embodiment, the present position information may include coordinates information of the mobile terminal 120 (e.g., longitude, latitude, and altitude).

In step S706 (FIG. 7A), the mobile terminal 120 sends the present position information to the server 130. Step S706 may include sub-steps S706a and S706b (FIG. 7B). In sub-step S706a, the mobile terminal 120 sends the present position information, via a mobile network or other networks. In sub-step S706b, the server 130 receives the present position information of the mobile terminal 120.

In step S708, the server 130 retrieves the store location information and calculates the distance between the present position of the mobile terminal 120 and the location of the store. As part of step S708, the server 130 performs a test to compare if the distance between the present position of the mobile terminal 120 and the location of the store is equal to or less than a predetermined distance threshold. Optionally, server 130 may also check whether the distance crosses a second threshold. Optionally, server 130 may determine coordinates of mobile terminal 120 and then check whether a first of the coordinates (e.g., the longitude) is greater than a first threshold and less than second threshold, and also check whether a second of the coordinates (e.g. a latitude) is greater than a third threshold and less than fourth threshold (thereby checking whether the mobile terminal 120 is within a given rectangular region of the preset region). Similarly, optionally server 130 may check whether a third of the coordinates (e.g., the altitude) is greater than a fifth threshold and less than a sixth threshold (e.g., thereby checking whether the mobile terminal 120 is on the desired floor or set of floors of a building that are in the preset region).
If in step S708, it is determined that mobile device is less than a certain distance away or within a given range of thresholds, method 700 proceeds from step S708 to step S710. In step S710, the server 130 sends a confirmation message to the transaction terminal 110, so that the transaction terminal 110 may start communicating with the mobile terminal 120. Step S710 may includes sub-step S710a and S710b. In sub-step S710a, the server 130 sends a confirmation message, and in sub-step S710b, transaction terminal 110 receives the confirmation.
In step S712, the server 130 sends customer information associated with the mobile terminal 120 that is in the preset region to the transaction terminal 110. Step 712 may include sub-steps S712a-d. In optional sub-step S712a, after receiving the confirmation message, the transaction terminal 110 sends a request to the server 130 for customer information associated with the mobile terminal 120. In optional sub-step S712b, the server 130 receives the request from the transaction terminal 110. In sub-step S712c, the server 130 retrieves customer information from the customer database in the memory system of the server 130 and sends the customer information. In sub-step S712d, the customer information is then received by the transaction terminal 110. Optionally, as part of step S712, the server 130 sends order pickup information to the transaction terminal 110 to alert the store assistant to prepare the pickup order of the customer. Alternatively, the customer information and the order pickup information is sent from server 130 to transaction terminal 110 with the confirmation.
Step S714 (FIG. 7A) may include sub-steps S714a-i (FIG. 7B2). In step S714, the server 130 (in sub-step S714a) and/or the transaction terminal 110 (in sub-step S714b) sends commercial information, transaction information, and/or invitations for attracting the customer into the store to mobile terminal 120. Optionally, commercial information, transaction information, and/or invitations for attracting the customer into the store may include a game for the user of mobile terminal 120 to play. In sub-step S714b, commercial information, transaction information, and/or invitations for attracting the customer into the store, then in step S714c, are received by the mobile terminal 120. Optionally as part of S714, in sub-step S714d, a response is sent from the mobile terminal 120 (e.g., completion of games and/or other activities). Optionally as part of S714, in sub-steps S714e and f, the transaction terminal 110 and/or server 130 receives the response from the mobile terminal 120 (e.g., completion of games and/or other activities), and sends promotional offers to the mobile terminal 120. Optionally as part of S714, in sub-step S714g and S714h, the transaction terminal 110 and/or server 130 sends promotional offers (e.g., coupons and/or discounts), consumption list and/or payment request to the mobile terminal 120. Optionally, in sub-step S714i, mobile terminal 120 receives the consumption list and/or payment request.

Returning to step S708, if mobile terminal 120 failed the test and the mobile terminal 120 is considered to be outside the preset region associated with the store, then method 700 returns to step S704. Steps S704-S708 may be repeated until the mobile terminal 120 is determined to be within the preset region associated with the store.
In an embodiment, each of the steps of method 700 is a distinct step. In at least one embodiment, although depicted as distinct steps in FIGS. 7A, 7B1, and 7B2, steps S702-S714 may not be distinct steps. In other embodiments, method 700 may not have all of the above steps and/or may have other steps in addition to or instead of those listed above. The steps of method 700 may be performed in another order. Subsets of the steps listed above as part of method 700 may be used to form their own method.

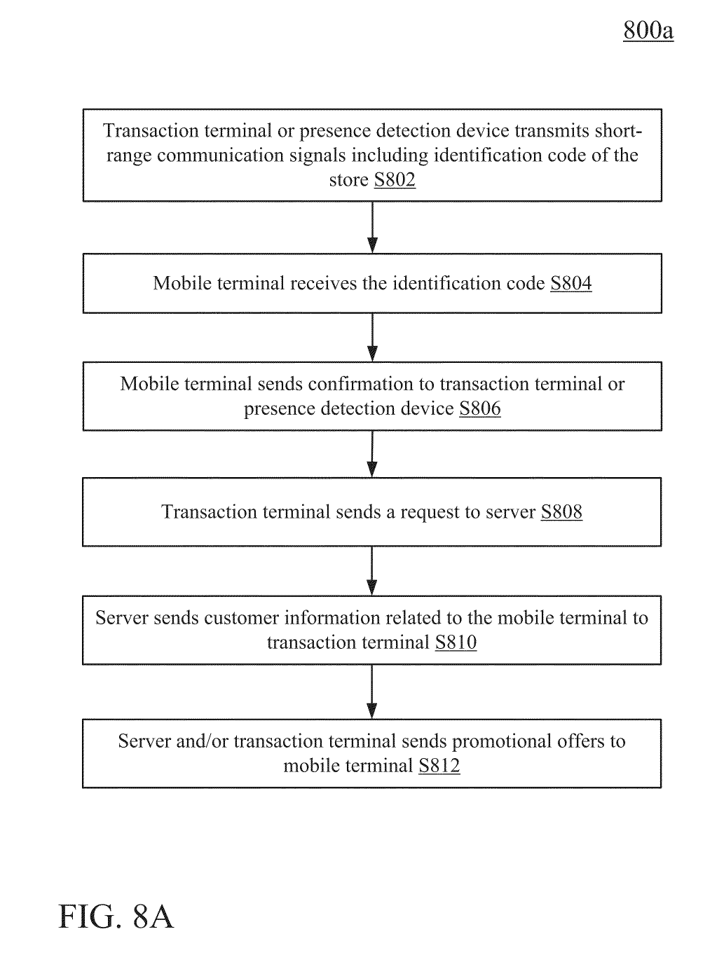

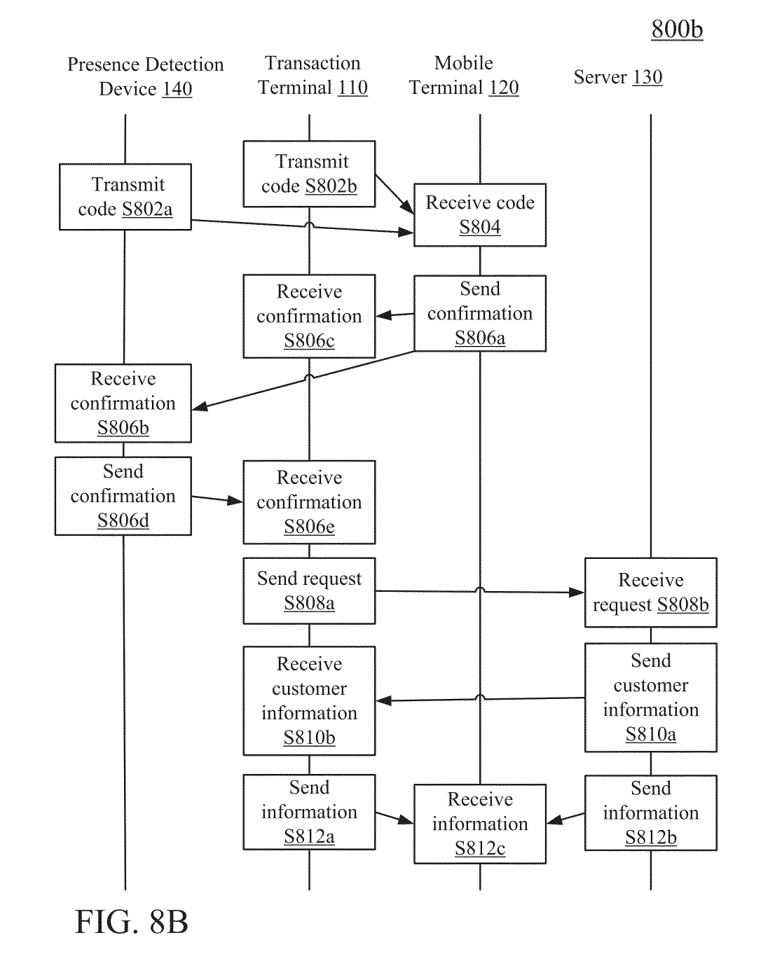

FIGS. 8A and 8B are flowcharts of an embodiment of another method 800 of determining whether the mobile terminal is present in the region of the store, which makes use of the presence detection device 140. FIG. 8B divides the steps of FIG. 8A into sub-steps showing which machine performs which sub-steps. The sub-steps and steps performed by a given machine may be considered steps of the method performed by that machine. In other words, FIG. 8B shows at least four methods—one that is performed by transaction terminal 110, one that is performed by mobile terminal 120, one that is performed by server 130, and one that is performed by presence detection device 140. In method 800, the location of the mobile terminal 120 and whether mobile terminal is within the preset region is determined using presence detection device 140.

In step S802 (FIG. 8A), the transaction terminal 110 or present detection device 140 transmits short-range communication signals that include at least an identification of the store where the transaction terminal 110 is installed. Step S802 (FIG. 8A) may include sub-steps S802a and S802b (FIG. 8B). In sub-step S802a, the presence detection device 140 that is connected to the transaction terminal 110 transmits short-range communication signals including the identification code. In sub-step S802b, the transaction terminal 110 that may include a presence detection device transmits signals including the identification code.

In step S804, the mobile terminal 120 receives the short-range communication signals when the mobile terminal 120 is in the effective communication range (e.g., the preset region) of the presence detection device 140 and/or the transaction terminal 110. The short range communication signal may include an identification code of the presence detection device 140.

In step S806, the mobile terminal 120, after receiving the identification code, sends a confirmation message via short-range communication to the presence detection device 140 and/or the transaction terminal 110. Step S806 (FIG. 8A) may include sub-steps S806a and S806b (FIG. 8B). In sub-step S806a, the mobile terminal 120 sends the confirmation message that may include the identification code of the store and/or information related to the mobile terminal 120, which, in sub-step S806b, is then received by the presence detection device 140 (in sub-step S806b) and/or the transaction terminal 110. In optional sub-step S806d, if the presence detection device 140 is installed external to the transaction terminal 110, the presence detection device 140 sends the confirmation message received from the mobile terminal 120 to the transaction terminal 110, via one or more wired and/or wireless connections. In optional sub-step S806e, the transaction terminal 110 receives the confirmation message from the presence detection device 140.

In step S808, the transaction terminal 110 sends a request to the server 130 for information related to the customer associated with the mobile terminal 120 that enters the preset region. Step S808 (FIG. 8A) may include sub-steps S808a and S808b (FIG. 8B). In sub-step S808a, the transaction terminal 110 may send information related to the mobile terminal 120 and a request for customer information, which in sub-step S808b is received by the server 130.

In step S810, the server 130 retrieves customer information based on the received information, and sends the customer information to the transaction terminal 110. Step S810 (FIG. 8A) may include sub-steps S810a and S810b (FIG. 8B). In sub-step S810a, the server 130 retrieves customer information from the customer database in the memory of the server 130 and transmits the customer information, which, in sub-step 810b, is then received by the transaction terminal. Optionally the customer information may include information about picking up an order, which may be displayed on the transaction terminal 110.

Step S812 (FIG. 8A) may include sub-steps S812a-c (FIG. 8B). In step S812, the transaction terminal 110 (in sub-step S812a) and/or the server 130 (in sub-step S812b) sends commercial information, transaction information, and/or invitations to the mobile terminal 120 for attracting the customer into the store. In sub-step S812c, the mobile terminal 120 receives the information and may display the information via a user interface. Optionally as part of S812, the transaction terminal 110 and/or server 130 receives interactions and/or responses from the mobile terminal 120 (e.g., completion of games and/or other activities), and send promotional offers to the mobile terminal 120. Optionally as part of S812, the transaction terminal 110 and/or the server 130 sends payment requests to the mobile terminal 120. Optionally as part of S812, the transaction terminal 110 and/or the server 130 sends reminders and/or invitations to the mobile terminal 120 for inviting the customer to redeem available promotional offers of the customer.

In an embodiment, each of the steps of method 800 is a distinct step. In at least one embodiment, although depicted as distinct steps in FIGS. 8A and 8B, steps S802-S812 may not be distinct steps. In other embodiments, method 800 may not have all of the above steps and/or may have other steps in addition to or instead of those listed above. The steps of method 800 may be performed in another order. Subsets of the steps listed above as part of method 800 may be used to form their own method.

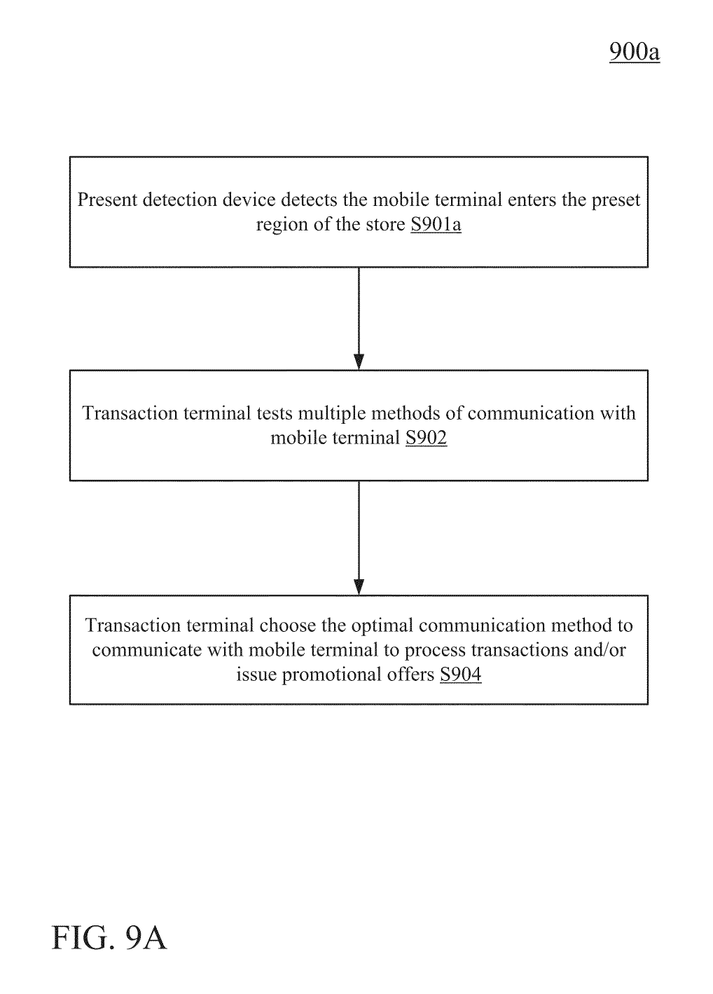

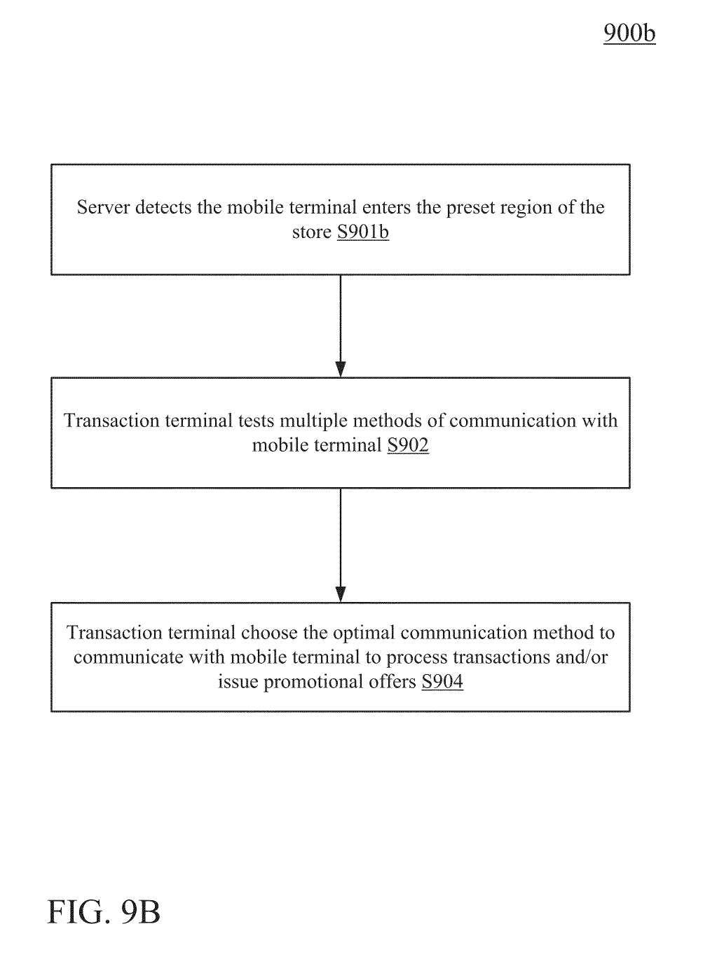

FIG. 9A is a flowchart of an embodiment of a method 900a of detecting the presence of the mobile terminal and implementing transactions and/or promotional offers.

In step S901a, the presence detection device 140 detects that the mobile terminal 120 enters the preset region associated with the store (e.g., the effective communicative range of the presence detection device 140 that is installed outside and/or inside the store). The presence detection device 140 may be installed external to the transaction terminal 110, or may be part of the transaction terminal 110. The methods and/or steps of detecting the presence of mobile terminal 120 in the preset region were discussed in conjunction with FIGS. 1, 4A, 4B, 8A and 8B.

Steps S902 and S904 may be similar to steps S602 and S604, respectively, which were discussed in conjunction with FIGS. 6A-C. In Steps S902 and S904, the transaction terminal 110 may communicate with the mobile terminals 120 within certain preset regions of the store as determined by the presence detection device 140.

In an embodiment, each of the steps of method 900a is a distinct step. In at least one embodiment, although depicted as distinct steps in FIG. 9A, steps S901a-S904 may not be distinct steps. In other embodiments, method 900a may not have all of the above steps and/or may have other steps in addition to or instead of those listed above. The steps of method 900a may be performed in another order. Subsets of the steps listed above as part of method 900a may be used to form their own method.

FIG. 9B is a flowchart of an embodiment of another method 900b of detecting the presence of the mobile terminal and implementing transactions and/or promotional offers.

In step S901b, the server 130 compares the present position of the mobile terminal 120 and the store location to determine whether the mobile terminal 120 enters the preset region associated with the store (e.g., within 200 meters from the store). The methods and/or steps of detecting the presence of mobile terminal 120 in the preset region were discussed in conjunction with FIGS. 1, 3, 7A and 7B.

Steps S902 and S904 were discussed in conjunction with FIG. 9A.

In an embodiment, each of the steps of method 900b is a distinct step. In at least one embodiment, although depicted as distinct steps in FIG. 9B, steps S901b-S904 may not be distinct steps. In other embodiments, method 900b may not have all of the above steps and/or may have other steps in addition to or instead of those listed above. The steps of method 900b may be performed in another order. Subsets of the steps listed above as part of method 900b may be used to form their own method.

In one embodiment, the transaction terminal 110 may be a tablet PC, which may include a near field communication (NFC) device (e.g., Samsung Galaxy Note 3), or may not include a built-in NFC device (e.g., Apple iPad 4). In at least one embodiment of the tablet PC not having a built-in NFC device, an external NFC device may be connected to the transaction terminal 110. The tablet PC acting as the transaction terminal 110 may be carried around by a store assistant to process payment transactions by retrieving information from physical forms of credit cards that include Visa payWave, MasterCard PayPass, and/or AmericanExpress ExpressPay. Then the transaction terminal 100 may further communicate with servers and/or payment gateways of the credit card companies to obtain payment authorization.

In another embodiment, the transaction terminal 110 is a tablet PC that includes a presence detection device for identifying mobile terminals near the transaction terminal 110. When the mobile terminal 120 is in the effective communication range of the transaction terminal 110 (e.g., in the neighborhood of the transaction terminal 110), the transaction terminal 110 may test various short-range and/or remote communication methods with the mobile terminal 120 of a customer, and choose an optimal communication mode to transmit transaction information to the mobile terminal 120 and/or send a payment request. The mobile terminal 120 may include multiple payment methods such as activated E-wallets (e.g., Google Wallet), online payment accounts, programs and/or accounts that are linked to credit/debit cards, digital stored-value cards (e.g., the Hong Kong Octopus smart card) and/or electronic promotional offers. The transaction terminal 110 may retrieve the multiple payment methods that are available to the mobile terminal 120 and send options of payment to the mobile terminal 120. After the customer selecting one payment type and/or coupon to redeem on the mobile terminal 120, the customer may pat the mobile terminal 120 on the transaction terminal 110, or move the mobile terminal 120 close enough to the transaction terminal 110 (e.g., in a distance of 0.1 to 10 cm) in order for the NFC device of the transaction terminal 110 to receive the payment information and execute a payment transaction. The transaction terminal 110 may also issue promotional offers to the mobile terminal 120 based on the payment transaction, the membership programs of the customer, and/or other factors. The optimal communication mode and the method to detect mobile terminals using the presence detection device were discussed in conjunction with FIG. 1. In at least one embodiment, the transaction terminal 110 that includes a presence detection device may be a mobile device, which is carried by a store assistant to assist customer close to the store assistant with transactions.

In yet another embodiment, the transaction terminal 110 is a tablet PC and may interact with a network payment account (e.g., PayPal account) of a customer. The transaction terminal 110 communicates with mobile terminals via optimal communication mode, when the mobile terminal enters a preset region defined by the presence detection device. The customer may select a payment method (e.g., to pay by PayPal account and/or to redeem stored coupon in a membership program) to process the payment. After receiving the selected payment method from the mobile terminal 120, the transaction terminal 110 displays the data of the customers (e.g., customer name, photograph) that are detected by the presence detection device installed near the transaction terminal 110, then the store assistant may confirm the identity of the customer who intends to pay. Further, the transaction terminal 110 may issue promotional offers to the mobile terminal 120 upon completion of the payment.

Alternatively, the transaction terminal 110 may be a desktop computer, a laptop computer, or a mobile device, which may includes various communication devices. Optionally the desktop computer of transaction terminal 110 may include card readers, scanners and/or cameras. The desktop computer of transaction terminal 110 may have similar function as described above as the transaction terminal 110 being a tablet PC.

In summary, the transaction terminal 110 of the system 100 communicates with the mobile terminal 120 that is in a preset region associated with the store for processing transactions and/or promotional offers via short-range communication. Optionally presence detection device 140 and/or server 130 may communicate with the mobile terminal 120 to determine whether the mobile terminal is within the preset region associated with the store. The transaction terminal 110 may retrieve information related to the customer associated with the mobile terminal 120 from server 130, and the transaction terminal 110 and/or server 130 may send commercial information, advertisements, and/or invitations to the mobile terminal 120 to attract the customer into the store. The transaction terminal 110 may select the optimal communication mode to communicate with the mobile terminal 120. The system 100 may support mobile payment methods using E-wallet, online payment account, and/or other electronic payment using the mobile terminal 120. The system 100 may also support other payment types that may not involve a mobile terminal, such as cash, credit/debit card, stored-value card, and/or available promotional offers of the customer. The system 100 may support all types of smart phones or mobile devices on the market. The transaction terminal 110 and/or server 130 may further issue promotional offers based on the transaction to the mobile terminal 120.

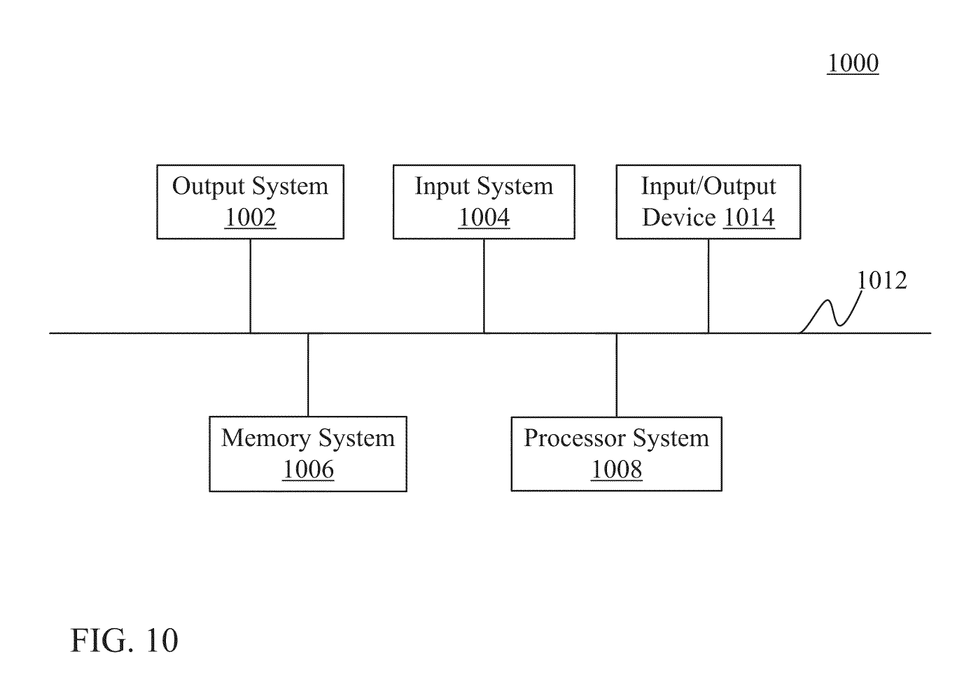

FIG. 10 shows a block diagram of an embodiment of a server 1000 in the system. Server 1000 may be the server 130 of FIG. 1. Server 1000 may include an output system 1002, an input system 1004, a memory system 1006, a processor system 1008, a communications system 1012, and an input/output device 1014. In other embodiments, server 1000 may include additional components and/or may not include all of the components listed above.

Output system 1002 may include any one of, some of, any combination of, or all of a monitor system, a handheld display system, a printer system, a speaker system, a connection or interface system to a sound system, an interface system to peripheral devices and/or a connection and/or interface system to a computer system, intranet, and/or internet, for example. Output system 1002 may also include an interface for communicating, via a network (e.g., the Internet) with the transaction terminal 110, the mobile terminal 120, and/or the presence detection device 140. Output system 1002 may also include an interface for communicating, via mobile network with the mobile terminal 120.

Input system 1004 may include any one of, some of, any combination of, or all of a keyboard system, a mouse system, a track ball system, a track pad system, buttons on a handheld system, a scanner system, a microphone system, a connection to a sound system, and/or a connection and/or interface system to a computer system, intranet, and/or internet (e.g., IrDA, USB), for example. Input system 1004 may receive communications, via a network from transaction terminal 110, the mobile terminal 120, and/or the presence detection device 140

Memory system 1006 may include, for example, any one of, some of, any combination of, or all of a long term storage system, such as a hard drive; a short term storage system, such as random access memory; a removable storage system, such as a floppy drive or a removable drive; and/or flash memory. Memory system 1006 may include cache memory accessible by a processor. Memory system 1006 may include one or more machine-readable mediums that may store a variety of different types of information. The term machine-readable medium is used to refer to any non-transient medium capable carrying information that is readable by a machine. One example of a machine-readable medium is a non-transient computer-readable medium. Another example of a machine-readable medium is paper having holes that are detected that trigger different mechanical, electrical, and/or logic responses. In at least one embodiment, memory system 1006 may include software for communicating with the transaction terminal 110, the mobile terminal 120, and/or the presence detection device 140, which may include machine instructions for transmitting and receiving information related to transaction information, commercial information, and/or promotional offers to the mobile terminal and optionally for transmitting information to the transaction terminal. In at least one embodiment, memory system 1006 may include the customer database, store database, promotion database. In at least one embodiment, memory system 1006 may include software, which when invoked, implements steps S702, S706b, S708, S710a, S712b, S712c, S714a, S720 (FIGS. 7A and 7B), S808b, S810a, S812a (FIGS. 8A and 8B), and S901b (FIG. 9B).

Processor system 1008 may include any one of, some of, any combination of, or all of multiple parallel processors, a single processor, a system of processors having one or more central processors and/or one or more specialized processors dedicated to specific tasks. In at least one embodiment, processor system 1008 may implement machine instructions stored in memory system 1006, such as software for storing, managing, tracking, transmitting, updating information related to customers, stores, transactions, and/or promotional offers, and communicating with transaction terminal, mobile terminal, and/or presence detection device. In at least one embodiment, processor system 1008 may access and manage the customer database, store database, promotion database. In at least one embodiment, processor system 1008 may implement steps S702, S706b, S708, S710a, S712b, S712c, S714a, S720 (FIGS. 7A and 7B), S808b, S810a, S812a (FIGS. 8A and 8B), and S901b (FIG. 9B).

Communications system 1012 communicatively links output system 1002, input system 1004, memory system 1006, processor system 1008, and/or input/output system to each other. Communications system 1012 may include any one of, some of, any combination of, or all of electrical cables, fiber optic cables, and/or means of sending signals through air or water (e.g. wireless communications), for example. Some examples of means of sending signals through air and/or water include systems for transmitting electromagnetic waves such as infrared and/or radio waves and/or systems for sending sound waves.

Input/output system 1014 may include devices that have the dual function as input and output devices. For example, input/output system 1014 may include one or more touch sensitive screens, which display an image and therefore are an output device and accept input when the screens are pressed by a finger or stylus, for example. The touch sensitive screens may be sensitive to heat and/or pressure. One or more of the input/output devices may be sensitive to a voltage or current produced by a stylus, for example. Input/output system 1014 is optional, and may be used in addition to or in place of output system 1002 and/or input system 1004.

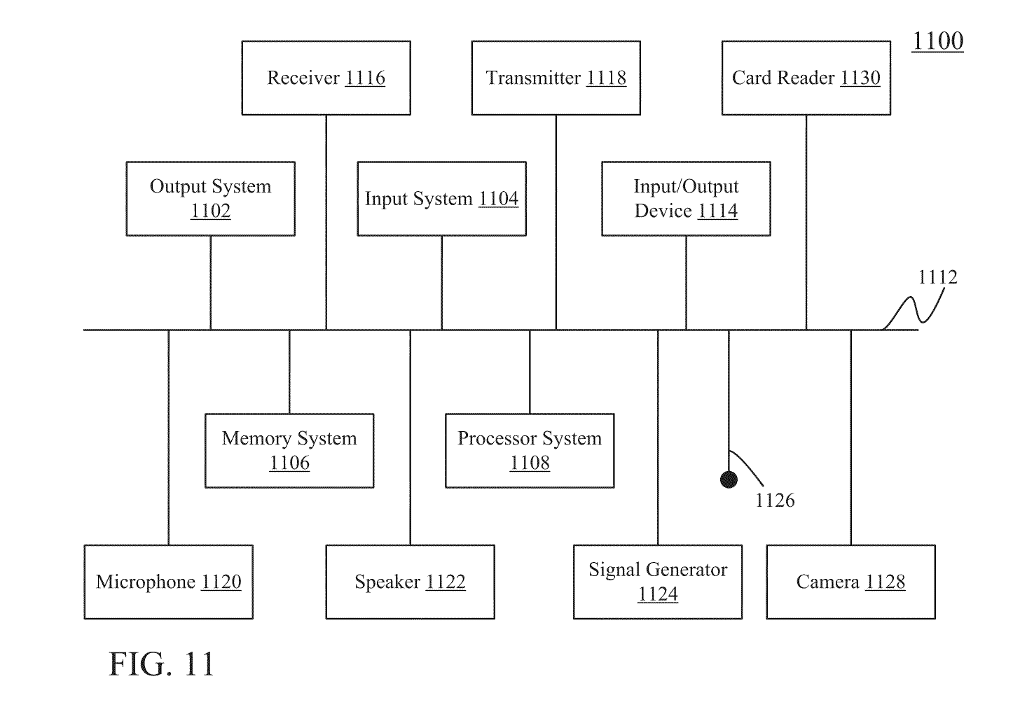

FIG. 11 shows a block diagram of an embodiment of a transaction terminal 1100 in the system. Transaction terminal 1100 may be the transaction terminal 110 of FIG. 1. Transaction terminal 1100 may include an output system 1102, an input system 1104, a memory system 1106, a processor system 1108, a communications system 1112, an input/output device 1114, a receiver 1116, a transmitter 1118, a microphone 1120, a speaker 1122, a signal generator 1124, an antenna 1126, a camera 1128, and a card reader 1130. In other embodiments, transaction terminal 1100 may include additional components and/or may not include all of the components listed above.

Output system 1102, input system 1104, memory system 1106, processor system 1108, communications system 1112, input/output system 1114 are similar to output system 1002, input system 1004, memory system 1006, processor system 1008, communications system 1012, and input/output system 1014, respectively, which were discussed in conjunction with FIG. 10. However, memory system 1106 and processor system 1108 differ from memory system 1006 and processor system 1008, respectively in the information stored and the instructions stored and implemented. Memory system 1106 of the transaction terminal 1100 stores information related to transactions and/or inventory. Memory system 1106 also includes machine instructions for implementing steps S602a, S602d, S602e, S604a, S604d1, S604e, S604f, S604h (FIGS. 6A-C), S710b, S712a, S712d, S714c (FIGS. 7A and 7B), S802b, S806c, S806e, S808a, S810b, S812a (FIGS. 8A and 8B), and S902, S904 (FIGS. 9A and 9B). Processor system 1108 implements steps S602a, S602d, S602e, S604a, S604d1, S604e, S604f, S604h (FIGS. 6A-C), S710b, S712a, S712d, S714c (FIGS. 7A and 7B), S802b, S806c, S806e, S808a, S810b, S812a (FIGS. 8A and 8B), and S902, S904 (FIGS. 9A and 9B).

Receiver 1116 processes the signals received from server, presence detection device, and/or mobile terminal. Transmitter 1118 prepares signals for transmission and transmits signals to mobile terminal, presence detection device, and/or server. Optionally microphone 1120 receives audio signals from mobile terminal (which are processed by receiver 1116). Speaker 1122 produces audio signals (based on the signal prepared by transmitter 1118), which may be sent to mobile terminal. In an embodiment, speaker 1122 produces a near field signal. Signal generator 1124 produces signals, which may be converted into electromagnetic signals and/or audio signals. Antenna 1126 may send electromagnetic signals (based on the signal prepared by transmitter 1118) and receive electromagnetic signals (which are processed by receiver 1116). Antenna 1126 is an electromagnetic sensor. Antenna 1126 may have a separate transmitter and receiver than that of transmitter 1118 and receiver 1120. Camera 1128 is a camera that may come with the transaction terminal 1100, or may be external to the transaction terminal 1100. Camera 1128 may scan and/or photograph barcodes or other information for processing payments. Card reader 1130 is a device that can read magnetic strips and/or chips of cards such as credit/debit cards, stored-value cards, and/or gift cards.

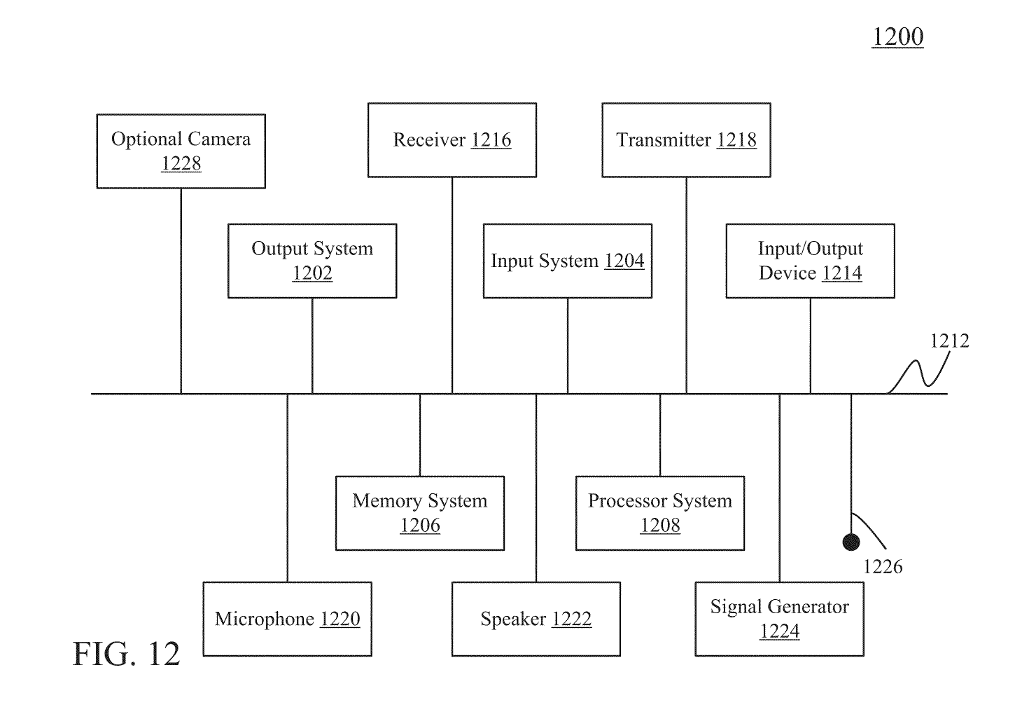

FIG. 12 shows a block diagram of an embodiment of a mobile terminal 1200 in the system. Mobile terminal 1200 may be either of the mobile terminals 120, 320a-n, 520a, and 520b. Mobile terminal 1200 may include an output system 1202, an input system 1204, a memory system 1206, a processor system 1208, a communications system 1212, an input/output device 1214, a receiver 1216, a transmitter 1218, a microphone 1220, a speaker 1222, a signal generator 1224, an antenna 1226, and an optional camera 1228. In other embodiments, mobile terminal 1200 may include additional components and/or may not include all of the components listed above.

Output system 1202, input system 1204, memory system 1206, processor system 1208, communications system 1212, input/output system 1214 are similar to output system 1002, input system 1004, memory system 1006, processor system 1008, communications system 1012, and input/output system 1014, respectively, which were discussed in conjunction with FIG. 10.
However, memory system 1206 and processor system 1208 differ from memory system 1006 and processor system 1008, respectively in the information stored and the instructions stored and implemented. Memory system 1206 of mobile terminal 1200 stores information related to the customer, which may include personal information, the user account, promotional offers, and/or payment information. Memory system 1206 also includes machine instructions for method 600 (FIGS. 6A-C), 700 (FIGS. 7A and 7B), 800 (FIGS. 8A and 8B), 900a and 900b (FIGS. 9A and 9B). Processor system 1208 of mobile terminal 1200 implements the machine instructions stored in the memory system 1206 including the machine instructions for method 600 (FIGS. 6A-C), 700 (FIGS. 7A and 7B), 800 (FIGS. 8A and 8B), 900a and 900b (FIGS. 9A and 9B). In at least one embodiment, memory system 1206 of mobile terminal 1200 may include a smart card chip capable of storing the instructions mentioned above, such as a SIM card or a Secure Memory Card.

Receiver 1216 processes the signals received from the transaction terminal 110, presence detection device 140, and/or server 130. Transmitter 1218 prepares signals for transmission to the server 130, transaction terminal 110 and/or presence detection device 140. Microphone 1220 receives audio signals from transaction terminal 110 and/or presence detection device 140 (which are processed by receiver 1216). Speaker 1222 produces audio signals, which may be sent to the transaction terminal and/or presence detection device (in addition to being used for carrying on a conversation during a phone call). Signal generator 1224 produces signals, which may be converted into electromagnetic signals and/or audio signals. Antenna 1226 may send and receive electromagnetic signal. Antenna 1226 may be an electromagnetic sensor. Optional camera 1228 is a camera that may come with the mobile terminal.

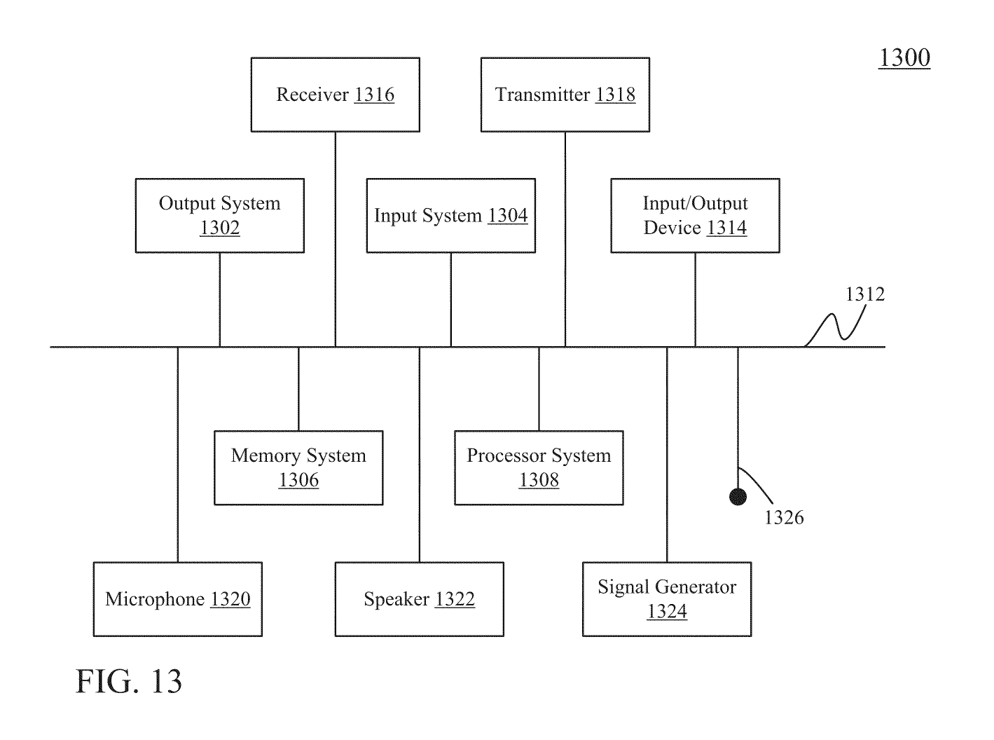

FIG. 13 shows a block diagram of an embodiment of a presence detection device 1300 in the system. Presence detection device 1300 may be either of the presence detection device 140, 441, 442, and 542. Presence detection device 1300 may include an output system 1302, an input system 1304, a memory system 1306, a processor system 1308, a communications system 1312, an input/output device 1314, a receiver 1316, a transmitter 1318, a microphone 1320, a speaker 1322, a signal generator 1324, and an antenna 1326. In other embodiments, presence detection device 1300 may include additional components and/or may not include all of the components listed above.

The output system 1302, input system 1304, memory system 1306, processor system 1308, communications system 1312, and input/output system 1314 are similar to output system 1002, input system 1004, memory system 1006, processor system 1008, communications system 1012, and input/output system 1014, respectively, which were discussed in conjunction with FIG. 10.

However, memory system 1206 and processor system 1208 differ from memory system 1006 and processor system 1008, respectively in the information stored and the instructions stored and implemented. Memory system 1306 of presence detection device 1300 stores information related to information related to the store (e.g., identification code, installation location of presence detection device 1300) and/or instructions for transmitting signals to, and/or receiving signals from, the presence detection device 1300 and the mobile terminal 120, transaction terminal 110, and/or server 130. Memory system 1306 also includes machine instructions for steps S802a, S806b, S806d (FIGS. 8A and 8B), and S901a (FIG. 9A). Processor system 1308 of presence detection device 1300 implements the machine instructions stored in the memory system 1306 including the machine instructions for steps S802a, S806b, S806d (FIGS. 8A and 8B), and S901a (FIG. 9A).

Receiver 1316 processes the signals received from the mobile terminal, transaction terminal, and/or server. Transmitter 1318 prepares signals for transmission to the mobile terminal including identification code of the store, for example. Transmitter 1318 may also prepare signals for transmission to server and/or transaction terminal. Microphone 1320 receives audio signals from mobile terminal and/or transaction terminal (which are processed by receiver 1316). Speaker 1322 produces audio signals, which may be sent to the mobile terminal and/or transaction terminal. Signal generator 1324 produces signals, which may be converted into electromagnetic signals and/or audio signals. Antenna 1326 may send and/or receive electromagnetic signal. Antenna 1326 may be an electromagnetic sensor.

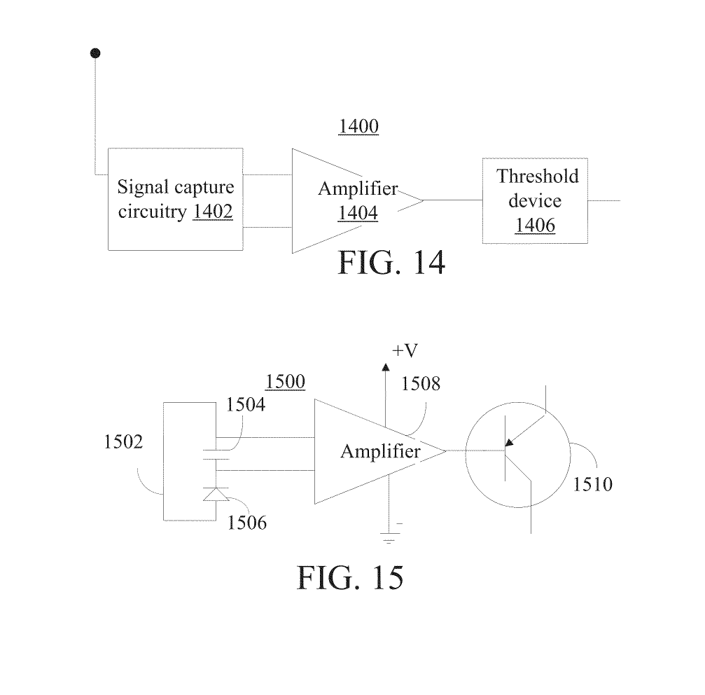

FIG. 14 shows a diagram of a mobile terminal detector 1400 that may be used in the presence detector of the systems of FIG. 1 and FIG. 13. Mobile terminal detector 1400 has an antenna 1402, signal capture circuitry 1404, amplifier 1406, and threshold device 1408. In other embodiments, mobile terminal detector 1400 may include additional components and/or may not include all of the components listed above.

Antenna 1402 picks up signals from the environment. Optionally antenna 1402 may be in series with a capacitor chosen to tune the antenna to frequencies between about 900 MHz and 3.3 GHz. Similarly, the length of the antenna may be chosen to be proportional to the desired wavelength (e.g., between 18 mm and 10 cm). Signal capture circuitry 1404 may include one or more capacitors, diodes, loops, and resistors to form a circuit with a resonant frequency that is close to the frequencies of the mobile terminal (e.g., a cell phone). Amplifier 1406 increases the signal of the signal capture circuit 1404. The signal picked up from a mobile terminal is relatively weak (e.g. 2V or less depending on how far the mobile terminal 120 is from mobile terminal detector 1400). Threshold device 1408 acts as a switch that turns on when the signal from the amplifier 1406 is above a particular threshold. Threshold device 1408 filters out noise, and may send a signal to a processor, which may indicate to the processor to send signal to the mobile terminal 110 that was detected.

FIG. 15 shows a diagram of an example of the mobile terminal detector 1500 which may be an example of the mobile terminal detector of FIG. 14. Mobile terminal detector 1500 may include loop 1502, capacitor 1504, diode 1506, amplifier 1508, and transistor 1510. In other embodiments, mobile terminal detector 1500 may include additional components and/or may not include all of the components listed above.

Loop 1502 acts as an antenna and has a width and/or length that is about the same size as the wavelength of the signals from the mobile terminal 110. For example, loop 1502 may be a square having a length between 3 cm or 3.7 cm and 15 cm (3.7 cm works for 3 GHz signals and 7.5 cm works well for picking up 1000 MHz signals). Loop 1502 may be replaced with a straight conductive rod antenna.

Capacitor 1504 may increase the sensitivity of the loop. In an embodiment capacitor 1504 may have a capacitance of 0.1 μF. Other values of capacitors may be used. Diode 1506 has a small additional capacitance (e.g., 3 pF) and also increase the sensitivity of the loop 1502. Although there needs to be at least one diode or capacitor, both are not needed. Amplifier 1508 may be an embodiment of amplifier 1406. Amplifier 1508 receives the voltage across capacitor 1504. Amplifier 1508 amplifies the signal across capacitor 1504. In other embodiments, amplifier 1508 may amplify the signal from across a diode or resistor and amplifies the signal. Transistor 1510 receives the output from amplifier 1508 at the bias of the transistor 1510. When the voltage from amplifier 1508 is above a threshold, the bias voltage creates an electrical connection between the source and drawing of the transistor allowing electrical signals to flow, which may be sent to the a processor and/or trigger sending a message to mobile terminal 110. Another threshold device may be substituted for transistor 1510.

### ALTERNATIVES AND EXTENSIONS

Each embodiment disclosed herein may be used or otherwise combined with any of the other embodiments disclosed. Any element of any embodiment may be used in any embodiment.

Although the invention has been described with reference to specific embodiments, it will be understood by those skilled in the art that various changes may be made and equivalents may be substituted for elements thereof without departing from the true spirit and scope of the invention. In addition, modifications may be made without departing from the essential teachings of the invention.

1. A method, comprising:
sending, from a transaction terminal to a mobile terminal of a customer, signals using multiple types of communication methods, the transaction terminal having a processor system including at least one processor, a memory system storing one or more machine instructions on one or more non-transitory computer readable media, and a network interface for communicating with at least the mobile terminal;
receiving, at the transaction terminal from the mobile terminal, confirmation of receiving signals of one or more of the multiple types of communication methods;
selecting by the transaction terminal an optimal communication method from the one or more of the multiple types of communication methods confirmed by the mobile terminal;
sending transaction information from the transaction terminal to the mobile terminal via the optimal communication method; and
wherein the multiple types of communication methods include at least a short-range communication method.

2. The method of claim 1, wherein
the multiple types of communication methods includes one or more of WiFi communication, Bluetooth communication, audio signal communication, and near field communication.

3. The method of claim 1, wherein
the optimal communication method is a method that the transaction terminal has an indication requires less data that needs to be resent in case of an error when compared to other methods of the multiple types of communication methods confirmed by the mobile terminal.

4. The method of claim 1, further comprising
generating transaction information by the transaction terminal, wherein the transaction information includes at least a consumption list and transaction amount.

5. The method of claim 4, further comprising
calculating by the transaction terminal promotional offer information based on the transaction amount.

6. The method of claim 1, wherein
the transaction information includes at least a payment request.

7. The method of claim 6, wherein
the payment request includes options of available payment methods that the transaction terminal and the mobile terminal support.

8. The method of claim 6, further comprising
receiving payment information at the transaction terminal;
processing payment by the transaction terminal using the payment information; and
sending promotional offer information from the transaction terminal to the mobile terminal;
wherein the promotional offer information is issued based on the transaction information.

9. The method of claim 8, wherein
the transaction terminal receives mobile payment information from the mobile terminal only when a communication distance between the transaction terminal and the mobile terminal is less than 10 cm.

10. The method of claim 8, wherein
the transaction terminal receives payment information by reading at least one of a magnetic strip, a chip, and a barcode.

11. The method of claim 1, further comprising
sending from the transaction terminal to the mobile terminal information including at least one of advertisements, promotional offers, receipts, consumption lists, order pickup information, membership programs, and invitations to games.

12. The method of claim 1, further comprising
receiving, at the transaction terminal from the mobile terminal, a message about a pickup order; and
displaying at the transaction terminal the message about the pickup order.

13. The method of claim 1, further comprising
receiving at the transaction terminal a message when the mobile terminal of the customer enters a preset region of a store;
sending, from the transaction terminal to a server, a request for customer information; and
receiving, at the transaction terminal from the server, the customer information.

14. The method of claim 13, wherein
the preset region associated with the store is within a predetermined distance from the store, wherein the server receives presence position information from the mobile terminal and calculates the distance between the store and the mobile terminal, wherein the server sends a message to the transaction terminal when the distance between the store and the mobile terminal is equal to or less than the predetermined distance.

15. The method of claim 13, wherein
the preset region associated with the store is within an effective communication range of a presence detection device, the presence detection device having at least short-range communication devices for communicating with at least the mobile terminal, wherein the presence detection device sends a message to the transaction terminal when the mobile terminal enters the effective communication range.

16. The method of claim 13, wherein
the customer information includes at least one of customer name, sex, age, contact information, photographs, membership programs, ranking in the membership programs, consumption information, pickup order information, payment methods, purchasing history, available promotional offers, personal preferences, clicked advertisements, searching history, education, current employer, places visited, searching keywords, and social circles.

17. The method of claim 13, further comprising
after the mobile terminal entering the preset region, sending, from the transaction terminal to the mobile terminal, commercial information about the store.

18. The method of claim 13, further comprising
after the mobile terminal entering the preset region, sending, from the server to the mobile terminal, commercial information about the store.

19. The method of claim 13, further comprising
receiving, at the server from the mobile terminal, a message about a pickup order of the customer;
after the mobile terminal enters the preset region, send, from the server to the transaction terminal, the message about the pickup order; and
displaying at the transaction terminal the message about the pickup order.

20. A method, comprising
storing at a server location information of a store, the server having a processor system including at least one processor, a memory system storing one or more machine instructions on one or more non-transitory computer readable media, and a network interface for communicating with at least a transaction terminal and a mobile terminal of a customer;
receiving, at the server from the mobile terminal, present position information of the mobile terminal;
calculating, by the server, a distance between the present position information of the mobile terminal and the location information of the store;
comparing, by the server, the distance and a predetermined distance threshold;
sending a message, from the server to the transaction terminal if the distance is equal to or less than the predetermined distance threshold;
receiving, at the server from the transaction terminal, a request for customer information associated with the mobile terminal;
sending, from the server to the transaction terminal, the customer information.

21. The method of claim 20, further comprising
sending, from the server to the mobile terminal, at least one of commercial information about the store, advertisements, promotional offers, and payment options.

22. The method of claim 20, further comprising
receiving, at the server from the mobile terminal, a message about a pickup order; and
if the distance is equal to or less than the predetermined distance threshold, sending, from the server to the transaction terminal, the message about the pickup order.

23. A method, comprising
sending, from a presence detection device, short-range communication signals including at least an identification code of a store, the presence detection device having at least short-range communication devices for communicating with at least a mobile terminal of a customer, the presence detection device being communicatively connected to a transaction terminal;
receiving, at the presence detection device from the mobile terminal, a confirmation of receiving the identification code, when the mobile terminal is in an effective communication range of the presence detection device;
sending a message from the presence detection device to the transaction terminal.

24. A transaction terminal, comprising
a processor system having at least one processor,
a network interface,
a memory system storing one or more machine instructions on one or more non-transitory computer readable media; and
wherein the one or more machine instructions, when implemented, cause the processor system of the promotional offers terminal to implement a method including at least
sending, from the transaction terminal to a mobile terminal of a customer, signals using multiple types of communication methods;
receiving, at the transaction terminal from the mobile terminal, confirmation of receiving signals of one or more of the multiple types of communication methods;
selecting by the transaction terminal an optimal communication method from the one or more of the multiple types of communication methods;
sending transaction information from the transaction terminal to the mobile terminal; and
wherein the multiple types of communication methods include a short-range communication method.

25. The transaction terminal of claim 24, further comprising
at least signal generators for converting data into signals of the multiple types of communication methods;
at least signal transmitters for transmitting the generated signals; and
at least receivers for receiving signals of the multiple types of communication methods.

26. The transaction terminal of claim 24, further comprising at least one of
a near field communication device for transmitting and receiving near field communication signals;
a Bluetooth device for transmitting and receiving Bluetooth signals;
a speaker and microphone for transmitting and receiving audio signals;
a WiFi device for pushing commercial information to the mobile terminal;
a camera or scanner for reading barcodes to complete payment transactions;
a card reader for reading magnetic strips or chips to complete payment transactions; and
wherein the near field communication device, the Bluetooth device, or the speaker and microphone serves to retrieve mobile payment information from the mobile terminal and transmitting promotional offer information to the mobile terminal.

27. The transaction terminal of claim 24, wherein
the optimal communication method is a method that includes an indicator for indicating, by the transaction terminal, when less data needs to be re-sent, in case of an error, in comparison to other methods of the multiple types of communication methods confirmed by the mobile terminal.

28. The transaction terminal of claim 24, the method implemented by the one or more machine instructions further including
generating transaction information by the transaction terminal, wherein the transaction information includes at least a consumption list and transaction amount.

29. The transaction terminal of claim 28, the method implemented by the one or more machine instructions further including
calculating by the transaction terminal promotional offer information based on the transaction amount.

30. The transaction terminal of claim 24, wherein
the transaction information includes at least a payment request.

31. The transaction terminal of claim 30, wherein
the payment request includes options of available payment methods that the transaction terminal and the mobile terminal support.

32. The transaction terminal of claim 30, the method implemented by the one or more machine instructions further including
receiving payment information at the transaction terminal;
processing payment by the transaction terminal using the payment information;
sending promotional offer information from the transaction terminal to the mobile terminal;
wherein the promotional offer information is issued based on the transaction information.

33. The transaction terminal of claim 32, wherein
the transaction terminal receives payment information from the mobile terminal only when a communication distance between the transaction terminal and the mobile terminal is less than 10 cm.

34. The transaction terminal of claim 32, wherein
the transaction terminal receives payment information by reading at least one of a magnetic strip, a chip, and a barcode.

35. The transaction terminal of claim 24, the method implemented by the one or more machine instructions further including
sending from the transaction terminal to the mobile terminal information including at least one of advertisements, promotional offers, receipts, consumption lists, order pickup information, membership programs, and invitations to games or other activities.

36. The transaction terminal of claim 24, the method implemented by the one or more machine instructions further including
receiving, at the transaction terminal from the mobile terminal, a message about a pickup of an order; and
displaying at the transaction terminal the message about the pickup of the order.

37. The transaction terminal of claim 24, the method implemented by the one or more machine instructions further including
receiving at the transaction terminal a message when the mobile terminal of the customer enters a preset region of a store;
sending, from the transaction terminal to a server, a request for customer information; and
receiving, at the transaction terminal from the server, the customer information.

38. The transaction terminal of claim 37, wherein
the preset region associated with the store is within a predetermined distance from the store, wherein the server receives presence position information from the mobile terminal and calculates the distance between the store and the mobile terminal, wherein the server sends a message to the transaction terminal when the distance between the store and the mobile terminal is equal to or less than the predetermined distance.

39. The transaction terminal of claim 37, wherein
the preset region associated with the store is within an effective communication range of a presence detection device, the presence detection device having at least short-range communication devices for communicating with at least the transaction terminal, wherein the transaction terminal receives a message from the presence detection device when the mobile terminal enters the effective communication range.

40. The transaction terminal of claim 37, the method implemented by the one or more machine instructions further including
after the mobile terminal enters the preset region, sending, from the transaction terminal to the mobile terminal, commercial information about the store.

41. The transaction terminal of claim 37, the method implemented by the one or more machine instructions further including
after the mobile terminal enters the preset region, sending, from the server to the mobile terminal, commercial information about the store.

42. The transaction terminal of claim 37, the method implemented by the one or more machine instructions further including
receiving, at the server from the mobile terminal, a message about a pickup of an order of the customer;
after the mobile terminal enters the preset region, sending, from the server to the transaction terminal, the message about the pickup order; and
displaying at the transaction terminal the message about the pickup of the order.

43. A server, comprising:
a processor system having at least one processor,
a network interface,
a memory system storing one or more machine instructions on one or more non-transitory computer readable media; and
wherein the one or more machine instructions, when implemented, cause the processor system of the server to implement a method including at least
storing at the server, information about a location of a store;
receiving, at the server from a mobile terminal, information about a present position of the mobile terminal;
calculating, by the server, at least one distance between the present position of the mobile terminal and a location associated with the store, based on the location of the store and on the information about the present position of the mobile terminal;
comparing, by the server, the distance and a predetermined distance threshold;
sending a message, from the server to the transaction terminal if the distance crosses the predetermined distance threshold;
receiving, at the server from the transaction terminal, a request for customer information associated with the mobile terminal; and
sending, from the server to the transaction terminal, the customer information

44. The server of claim 43, the method implemented by the one or more machine instructions further including
sending, from the server to the mobile terminal, at least one of commercial information about the store, advertisements, promotional offers, and payment options.

45. The server of claim 43, the method implemented by the one or more machine instructions further including
receiving, at the server from the mobile terminal, a message about a pickup of an order; and
if the distance is equal to or less than the predetermined distance threshold, sending, from the server to the transaction terminal, the message about the pickup order.

46. A presence detection device, comprising at least
transmitters for sending short-range communication signals including at least an identification code of a store; and
receivers for receiving signals from the mobile terminal including a confirmation of the mobile terminal receiving the identification code, when the mobile terminal is in an effective communication range of the presence detection device;
wherein the presence detection device is communicatively connected to a transaction terminal for sending a message when the mobile terminal enters the effective communication range; the presence detection device being configured to send a signal to the transaction terminal when the mobile terminal enters the effective communication range.
